(19) United States
(12) Patent Application Publication
(10) Pub. No.: US 2011/0136439 A1
(43) Pub. Date: Jun. 9, 2011

(54) Analyzing Wireless Technologies Based On Software-Defined Radio

(75) Inventors: Kun Tan, Beijing (CN); Jiansong Zhang, Beijing (CN); Yongguang Zhang, Beijing (CN)

(73) Assignee: Microsoft Corporation, Redmond, WA (US)

(21) Appl. No.: 12/631,548

(22) Filed: Dec. 4, 2009

(51) Int. Cl. H04B 17/00; H04M 3/00; G06F 13/14; G06F 3/00

(52) U.S. Cl. 455/67.11; 455/68; 710/305; 715/700

(57) ABSTRACT

An analysis application is adapted to be executed on a computing device for collecting data for analysis from a software-defined radio implemented on the same computing device or on a separate computing device for testing measurement and analysis of wireless standards, radio configurations, communication protocols and other radio technologies.

### BACKGROUND

Software-defined radio (SDR) holds the promise of fully programmable wireless communication systems, effectively supplanting conventional radio technologies, which typically have the lowest communication layers implemented primarily in fixed, custom hardware circuits. Realizing the promise of SDR in practice, however, has presented developers with a dilemma Many current SDR platforms are based on either programmable hardware such as field programmable gate arrays (FPGAs) or embedded digital signal processors (DSPs). Such hardware platforms can meet the processing and timing requirements of modern high-speed wireless protocols, but programming FPGAs and specialized DSPs can be a difficult task. For example, developers have to learn how to program each particular embedded architecture, often without the support of a rich development environment of programming and debugging tools. Additionally, such specialized hardware platforms can also be expensive, e.g., at least several times the cost of an SDR platform based on a general-purpose processor (GPP) architecture, such as a general-purpose Personal Computer (PC).

On the other hand, SDR platforms that use general-purpose PCs enable developers to use a familiar architecture and environment having numerous sophisticated programming and debugging tools available. Furthermore, using a general-purpose PC as the basis of an SDR platform is relatively inexpensive when compared with SDR platforms that use specialized hardware. However, the SDR platforms that use a general purpose PC typically have an opposite set of tradeoffs from the specialized architectures discussed above. For example, since PC hardware and software have not been specially designed for wireless signal processing, conventional PC-based SDR platforms can achieve only limited performance. For instance, some conventional PC-based SDR platforms typically achieve only a few Kbps throughput on an 8 MHz channel, whereas modern high-speed wireless protocols such as 802.11 support multiple Mbps data rates on a much wider 20 MHz channel. Thus, these performance constraints prevent developers from using PC-based SDR platforms to achieve the full fidelity of state-of-the-art wireless protocols while using standard operating systems and applications in a real-world environment, and inhibit using a PC platform for experimental uses, development and analysis of various radio technologies.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein provide for analysis, such as measurement, testing, and data analysis, of wireless standards, radio configurations, communication protocols and other radio technologies based on a software-defined radio and/or software-defined radio platform on a computing device.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 illustrates an exemplary architecture according to some implementations disclosed herein.

FIG. 2 illustrates an exemplary hardware and logical configuration of a computing device according to some implementations.

FIG. 3 illustrates a representation of an exemplary radio control board and RF front end according to some implementations.

FIG. 4 illustrates exemplary DMA memory access according to some implementations.

FIG. 5 illustrates an exemplary logical configuration according to some implementations.

FIG. 6A illustrates an algorithm optimization table according to some implementations.

FIG. 6B illustrates optimized PHY blocks according to some implementations.

FIG. 6C illustrates optimized PHY blocks according to some implementations.

FIG. 7A illustrates an exemplary memory layout for SIMD (Single Instruction Multiple Data) processing according to some implementations.

FIG. 7B illustrates a flowchart of an exemplary process for SIMD processing according to some implementations.

FIG. 7C illustrates an exemplary diagram showing processing using lookup tables according to some implementations.

FIG. 7D illustrates a flowchart of an exemplary process using lookup tables according to some implementations.

FIG. 8A illustrates an exemplary synchronized First-In-First-Out (FIFO) buffer according to some implementations.

FIG. 8B illustrates a flowchart of an exemplary process of a producer according to some implementations.

FIG. 8C illustrates a flowchart of an exemplary process of a consumer according to some implementations.

FIG. 9A illustrates an example of an SDR according to some implementations.

FIG. 9B illustrates an exemplary process for exclusively performing SDR processing on the one or more cores.

FIG. 10 illustrates exemplary MAC processing according to some implementations.

FIG. 11 illustrates an exemplary graphical user interface according to some implementations.

FIG. 12 illustrates an exemplary computing device implementing analysis innovations according to some implementations.

FIG. 13 illustrates a flowchart of an exemplary process for analysis of wireless standards or other radio technologies according to some implementations.

FIG. 14 illustrates an exemplary system implementing analysis innovations according to some implementations.

### DETAILED DESCRIPTION

### Overview

Implementations herein provide for real-time testing, measuring, analysis and reconfiguration of wireless standards and other radio technologies using one or more computing devices Implementations herein also present a fully programmable software-defined radio (SDR) platform and system able to be implemented on general-purpose computing devices, including personal computer (PC) architectures. For example, efficient and convenient testing, measuring and/or analyzing of various wireless standard configurations can be implemented using the SDR platform and computing device architecture described herein. Some implementations an analysis application for carrying out testing, measurement and/or analysis of radio technologies to execute on the same general-purpose computing device as the SDR. For example, the SDR may execute on one or more dedicated cores of the multi-core processor, while the analysis application is able to use one or more other cores of the multi-core processor. This further enables online feedback to be provided for adjusting parameters of the SDR or reconfiguring the SDR in real time, while also providing for greater ease of use for researchers for experimenting with various new or modified radio protocols, software radio configurations, hardware configurations, or the like, on the SDR platform provided herein. In additional implementations, analysis may also be carried out on a second computing device in communication with a first computing forming the SDR platform.

Implementations of the SDR herein combine the performance and fidelity of specialized-hardware-based SDR platforms with the programmability and flexibility of general-purpose processor (GPP) SDR platforms Implementations of the SDR herein use both hardware and software techniques to address the challenges of using general-purpose computing device architectures for high-speed SDR platforms. In some implementations of the SDR herein, hardware components include a radio front end for radio frequency (RF) reception and transmission, and a radio control board for high-throughput and low-latency data transfer between the radio front end and a memory and processor on the computing device.

Implementations of the SDR herein make use of features of multi-core processor architectures to accelerate wireless protocol processing and satisfy protocol-timing requirements. For example, implementations herein may use dedicated CPU cores, lookup tables stored in large low-latency caches, and SIMD (Single Instruction Multiple Data) processor extensions for carrying out highly efficient physical layer processing on general-purpose multiple-core processors. Some exemplary implementations described herein include an SDR that seamlessly interoperates with commercial 802.11a/b/g network interface controllers (NICs), and achieve performance that is equivalent to that of commercial NICs at multiple different modulations.

Furthermore, some implementations are directed to a fully programmable software radio platform and system that provides the high performance of specialized SDR architectures on a general-purpose computing device, thereby resolving the SDR platform dilemma for developers. Using implementations of the SDR herein, developers can implement and experiment with high-speed wireless protocol stacks, e.g., IEEE 802.11a/b/g/n, using general-purpose computing devices. For example, using implementations herein, developers are able to program in familiar programming environments with powerful programming and debugging tools on standard operating systems. Software radios implemented on the SDR herein may appear like any other network device, and users are able to run unmodified applications on the software radios herein while achieving performance similar to commodity hardware radio devices.

Furthermore, implementations of the SDR herein use both hardware and software techniques to address the challenges of using general-purpose computing device architectures for achieving a high-speed SDR. Implementations are further directed to an inexpensive radio control board (RCB) coupled with a radio frequency (RF) front end for transmission and reception. The RCB bridges the RF front end with memory of the computing device over a high-speed and low-latency PCIe (Peripheral Component Interconnect Express) bus. By using a PCIe bus, some implementations of the RCB can support 16.7 Gbps throughput (e.g., in PCIe×8 mode) with sub-microsecond latency, which together satisfies the throughput and timing requirements of modern wireless protocols, while performing all digital signal processing using the processor and memory of a general purpose computing device. Further, while examples herein use PCIe protocol, other high-bandwidth protocols may alternatively be used, such as, for example, HyperTransport™ protocol.

Additionally, to meet physical layer (PHY) processing requirements, implementations of the SDR herein leverage various features of multi-core architectures in commonly available general-purpose processors. Implementations of the SDR herein also include a software arrangement that explicitly supports streamlined processing to enable components of a signal-processing pipeline to efficiently span multiple cores. For example, implementations herein change the conventional implementation of PHY components to extensively take advantage of lookup tables (LUTs), thereby trading off memory in place of computation, which results in reduced processing time and increased performance. For instance, implementations herein substantially reduce the computational requirements of PHY processing by utilizing large, low-latency caches available on conventional GPPs to store the LUTs that have been previously computed. In addition, implementations of the SDR herein use SIMD (Single Instruction Multiple Data) extensions in existing processors to further accelerate PHY processing. Furthermore, to meet the real-time requirements of high-speed wireless protocols, implementations of the SDR herein provide a new kernel service, core dedication, which allocates processor cores exclusively for real-time SDR tasks. The core dedication can be used to guarantee the computational resources and precise timing control necessary for SDR on a general-purpose computing device. Thus, implementations of the SDR herein are able fully support the complete digital processing of high-speed radio protocols, such as 802.11a/b/g/n, CDMA, GSM, WiMax and various other radio protocols, while using a general purpose computing device. Further, it should be noted that while various radio protocols are discussed in the examples herein, the implementations herein are not limited to any particular radio protocol.

### Architecture Implementations

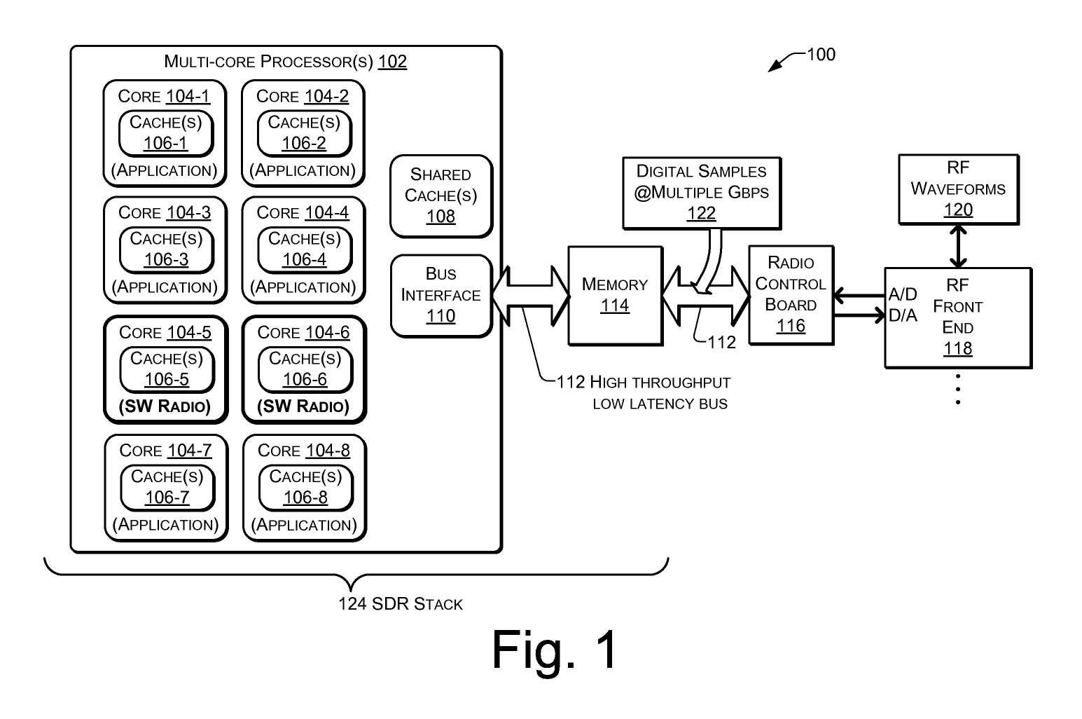

FIG. 1 illustrates an exemplary architecture of an SDR platform and system 100 according to some implementations herein. The SDR platform and system 100 includes one or more multi-core processors 102 having a plurality of cores 104. In the illustrated implementation, multi-core processor 102 has eight cores 104-1, . . . , 104-8, but other implementations herein are not limited to any particular number of cores. Each core 104 includes one or more corresponding onboard local caches 106-1, . . . , 106-8 that are used by the corresponding core 104-1, . . . 104-8, respectively, during processing. Additionally, multi-core processor 102 may also include one or more shared caches 108 and a bus interface 110. Examples of suitable multi-core processors include the Xenon™ processor available from Intel Corporation of Santa Clara, Calif., USA, and the Phenom™ processor available from Advanced Micro Devices of Sunnyvale, Calif., USA, although implementations herein are not limited to any particular multi-core processor. In the example illustrated, two of the cores, cores 104-5 and 104-6 are performing processing for the SDR, while the remaining cores 104-1 through 104-4 and 104-7 through 104-8 are performing processing for other applications, the operating system, or the like, as will be described additionally below. Further, in some implementations, two or more multi-core processors 102 can be provided, and cores 104 across the two or more multi-core processors can be used for SDR processing.

Multi-core processor 102 is in communication via bus interface 110 with a high-throughput, low-latency bus 112, and thereby to a system memory 114. As mentioned above, bus 112 may be a PCIe bus or other suitable bus having a high data throughput with low latency. Further, bus 112 is also in communication with a radio control board (RCB) 116. As is discussed further below, radio control board 116 may be coupled to an interchangeable radio front end (RF front end) 118. The RF front end 118 is a hardware module that receives and/or transmits radio signals through an antenna (not shown in FIG. 1). In some implementations of the SDR architecture herein, the RF front end 118 represents a well-defined interface between the digital and analog domains. For example, in some implementations, RF front end 118 may contain analog-to-digital (A/D) and digital-to-analog (D/A) converters, and necessary circuitry for radio frequency transmission, as is discussed further below.

During receiving, the RF front end 118 acquires an analog RF waveform 120 from the antenna, possibly down-converts the waveform to a lower frequency, and then digitizes the analog waveform into discrete digital samples 122 before transferring the digital samples 122 to the RCB 116. During transmitting, the RF front end 118 accepts a synchronous stream of software-generated digital samples 122 from a software radio stack 124 (i.e., software that generates the digital samples, as discussed below), and synthesizes the corresponding analog waveform 120 before emitting the waveform 120 via the antenna. Since all signal processing is done in software on the multi-core processor 102, the design of RF front end 118 can be rather generic. For example, RF front end 118 can be implemented in a self-contained module with a standard interface to the RCB 116. Multiple wireless technologies defined on the same frequency band can use the same RF front end hardware 118. Furthermore, various different RF front ends 118 designed for different frequency bands can be coupled to radio control board 116 for enabling radio communication on various different frequency bands. Therefore, implementations herein are not limited to any particular frequency or wireless technology.

According to some implementations herein, RCB 116 is a PC interface board optimized for establishing a high-throughput, low-latency path for transferring high-fidelity digital signals between the RF front end 118 and memory 114. The interfaces and connections between the radio front end 118 and multi-core processor 102 must enable sufficiently high throughput to transfer high-fidelity digital waveforms. For instance, in order to support a 20 MHz channel for 802.11 protocol, the interfaces should sustain at least 1.28 Gbps. By way of comparison, conventional interfaces, such as USB 2.0 (≦480 Mbps) or Gigabit Ethernet (≦1 Gbps) are not able to meet this requirement. Accordingly, to achieve the required system throughput, some implementations of the RCB 116 use a high-speed, low-latency bus 112, such as PCIe. With a maximum throughput of 64 Gbps (e.g., PCIe×32) and sub-microsecond latency, PCIe is easily able to support multiple gigabit data rates for sending and receiving wireless signals over a very wide band or over many MIMO channels. Further, the PCIe interface is typically common in many conventional general-purpose computing devices.

A role of the RCB 116 is to act as a bridge between the synchronous data transmission at the RF front end 118 and the asynchronous processing on the processor 102. The RCB 116 implements various buffers and queues, together with a large onboard memory, to convert between synchronous and asynchronous streams and to smooth out bursty transfers between the RCB 116 and the system memory 114. The large onboard memory further allows caching of pre-computed waveforms for quick transmission of the waveforms, such as when acknowledging reception of a transmission, thereby adding additional flexibility for software radio processing.

Finally, the RCB 116 provides a low-latency control path for software to control the RF front end hardware 118 and to ensure that the RF front end 118 is properly synchronized with the processor 102. For example, wireless protocols have multiple real-time deadlines that need to be met. Consequently, not only is processing throughput a critical requirement, but the processing latency should also meet certain response deadlines. For example, some Media Access Control (MAC) protocols also require precise timing control at the granularity of microseconds to ensure certain actions occur at exactly pre-scheduled time points. The RCB 116 of implementations herein also provides for such low latency control. Additional details of implementations of the RCB 116 are described further below.

### Exemplary Computing Device Implementation

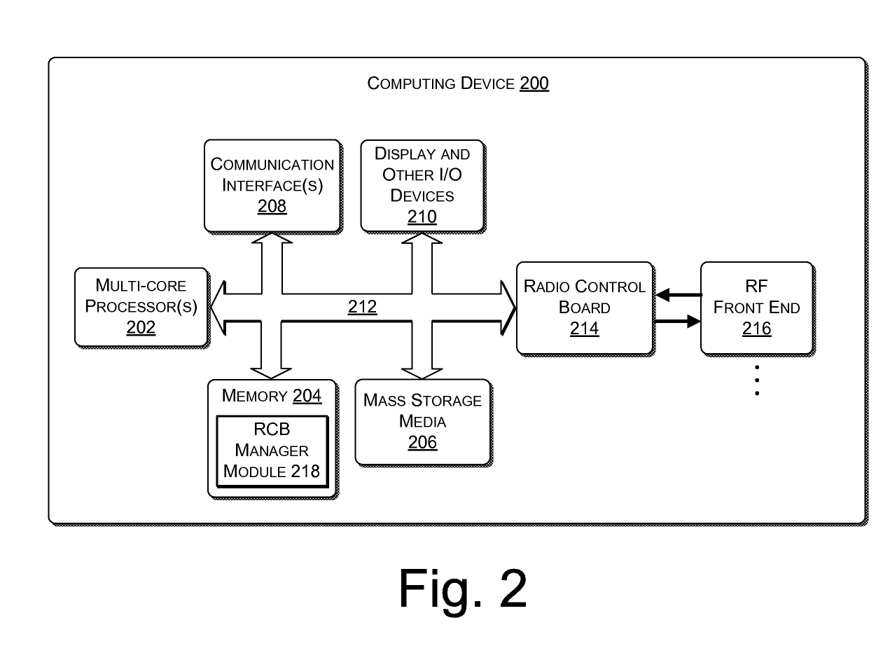

FIG. 2 illustrates an exemplary depiction of a computing device 200 that can be used to implement the SDR implementations described herein, such as the SDR platform and system 100 described above with reference to FIG. 1. The computing device 200 includes one or more multi-core processors 202, a memory 204, one or more mass storage devices or media 206, communication interfaces 208, and a display and other input/output (I/O) devices 210 in communication via a system bus 212. Memory 204 and mass storage media 206 are examples of computer-readable storage media able to store instructions which cause computing device 200 to perform the various functions described herein when executed by the processor(s) 202. For example, memory 204 may generally include both volatile memory and non-volatile memory (e.g., RAM, ROM, or the like). Further, mass storage media 206 may generally include hard disk drives, solid-state drives, removable media, including external and removable drives, memory cards, Flash memory, floppy disks, or the like. The computing device 200 can also include one or more communication interfaces 208 for exchanging data with other devices, such as via a network, direct connection, or the like, as discussed above. The display and other input/output devices 210 can include a specific output device for displaying information, such as a display, and various other devices that receive various inputs from a user and provide various outputs to the user, and can include, for example, a keyboard, a mouse, audio input/output devices, a printer, and so forth.

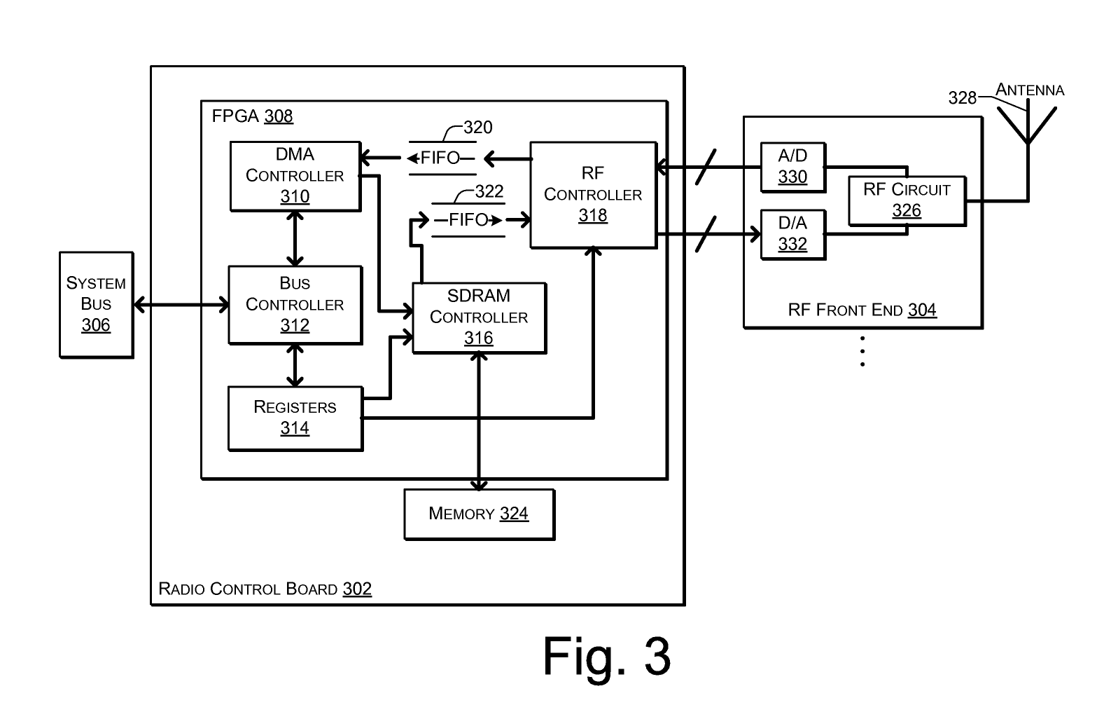

Computing device 200 further includes radio control board 214 and RF front end 216 for implementing the SDR herein. For example, system bus 212 may be a PCIe compatible bus, or other suitable high throughput, low latency bus. Radio control board 214 and RF front end 216 may correspond to radio control board 116 and RF front end 118 described above with reference to FIG. 1, and as also described below, such as with reference to FIG. 3. Furthermore, an RCB control module 218 may be stored in memory 204 or other computer-readable storage media for controlling operations on RCB 214, as is described additionally below. The computing device 200 described herein is only one example of a computing environment and is not intended to suggest any limitation as to the scope of use or functionality of the computer architectures that can implement the SDR herein. Neither should the computing device 200 be interpreted as having any dependency or requirement relating to any one or combination of components illustrated in the computing device 200.

Furthermore, implementations of SDR platform and system 100 described above can be employed in many different computing environments and devices for enabling a software-defined radio in addition to the example of computing device 200 illustrated in FIG. 2. Generally, many of the functions described with reference to the figures can be implemented using software, hardware (e.g., fixed logic circuitry), manual processing, or a combination of these implementations. The term “logic”, “module” or “functionality” as used herein generally represents software, hardware, or a combination of software and hardware that can be configured to implement prescribed functions. For instance, in the case of a software implementation, the term “logic,” “module,” or “functionality” can represent program code (and/or declarative-type instructions) that perform specified tasks when executed on a processing device or devices (e.g., CPUs or processors). The program code can be stored in one or more computer readable memory devices, such as memory 204 and/or mass storage media 206, or other computer readable storage media. Thus, the methods and modules described herein may be implemented by a computer program product. The computer program product may include computer-readable media having a computer-readable program code embodied therein. The computer-readable program code may be adapted to be executed by one or more processors to implement the methods and/or modules of the implementations described herein. The terms “computer-readable storage media”, “processor-accessible storage media”, or the like, refer to any kind of machine storage medium for retaining information, including the various kinds of memory and storage devices discussed above.

### Radio Control Board

FIG. 3 illustrates an exemplary implementation of a radio control board (RCB) 302 and RF front end 304, that may correspond to the RCB 116, 214 and RF front end 118, 216 described above. In the example illustrated, RCB 302 includes functionality for controlling the transfer of data between the RF front end 304 and a system bus 306, such as buses 112, 212 discussed above. In the illustrated embodiment, the functionality is a field-programmable gate array (FPGA) 308, which may be a Virtex-5 FPGA available from Xilinx, Inc., of San Jose, Calif., USA, one or more other suitable FPGAs, or other equivalent circuitry configured to accomplish the functions described herein. RCB 302 includes a direct memory access (DMA) controller 310, a bus controller 312, registers 314, an SDRAM controller 316, and an RF controller 318. RCB 302 further includes a first FIFO buffer 320 for acting as a first FIFO for temporarily storing digital samples received from RF front end 304, and a second FIFO buffer 322 for temporarily storing digital samples to be transferred to RF front end 304. The DMA controller 310 controls the transfer of received digital samples to the system bus 306 via the bus controller 312. SDRAM controller 316 controls the storage of data in onboard memory 324, such as digital samples, pre-generated waveforms, and the like. As an example only, memory 324 may consist of 256 MB of DDR2 SDRAM.

The RCB 302 can connect to various different RF front ends 304. One suitable such front end 304 is available from Rice University, Houston, Tex., USA, and is referred to as the Wireless Open-Access Research Platform (WARP) front end. The WARP front end is capable of transmitting and receiving a 20 MHz channel at 2.4 GHz or 5 GHz. In some implementations, RF front end 304 includes an RF circuit 326 configured as an RF transceiver for receiving radio waveforms from an antenna 328 and for transmitting radio waveforms via antenna 328. RF front end 304 further may include an analog-to-digital converter 330 and a digital-to-analog converter 332. As discussed above, analog-to-digital converter 330 converts received radio waveforms to digital samples for processing, while digital-to-analog converter 332 converts digital samples generated by the processor to radio waveforms for transmission by RF circuit 326. Furthermore, it should be noted that implementations herein are not limited to any particular front end 304, and in some implementations, the entire front end 304 may be incorporated into RCB 302. Alternatively, in other implementations, analog-to-digital converter 330 and digital-to-analog converter 332 may be incorporated into RCB 302, and RF front end 304 may merely have an RF circuit 326 and antenna 328. Other variations will also be apparent in view of the disclosure herein.

In the implementation illustrated in FIG. 3, the DMA controller 310 and bus controller 312 interface with the memory and processor on the computing device (not shown in FIG. 3) and transfer digital samples between the RCB 302 and the system memory on the computing device, such as memory 114, 204 discussed above. RCB software control module 218 discussed above with reference to FIG. 2 sends commands and reads RCB states through RCB registers 314. The RCB 302 further uses onboard memory 324 as well as small FIFO buffers 320, 322 on the FPGA 308 to bridge data streams between the processor on the computing device and the RF front end 304. When receiving radio waveforms, digital signal samples are buffered in on-chip FIFO buffer 320 and delivered into the system memory on the computing device when the digital samples fit in a DMA burst (e.g., 128 bytes). When transmitting radio waveforms, the large RCB memory 324 enables implementations of the RCB manager module 218 (e.g., FIG. 2) to first write the generated samples onto the RCB memory 324, and then trigger transmission with another command to the RCB. This functionality provides flexibility to the implementations of the SDR manager module 218 for pre-calculating and storing of digital samples corresponding to several waveforms before actually transmitting the waveforms, while allowing precise control of the timing of the waveform transmission.

It should be noted that in some implementations of the SDR herein, a consistency issue may be encountered in the interaction between operations carried out by DMA controller 310 and operations on the processor cache system. For example, when a DMA operation modifies a memory location that has been cached in the processor cache (e.g., L2 or L3 cache), the DMA operation does not invalidate the corresponding cache entry. Accordingly, when the processor reads that location, the processor might read an incorrect value from the cache. One naive solution is to disable cached accesses to memory regions used for DMA, but doing so will cause a significant degradation in memory access throughput.

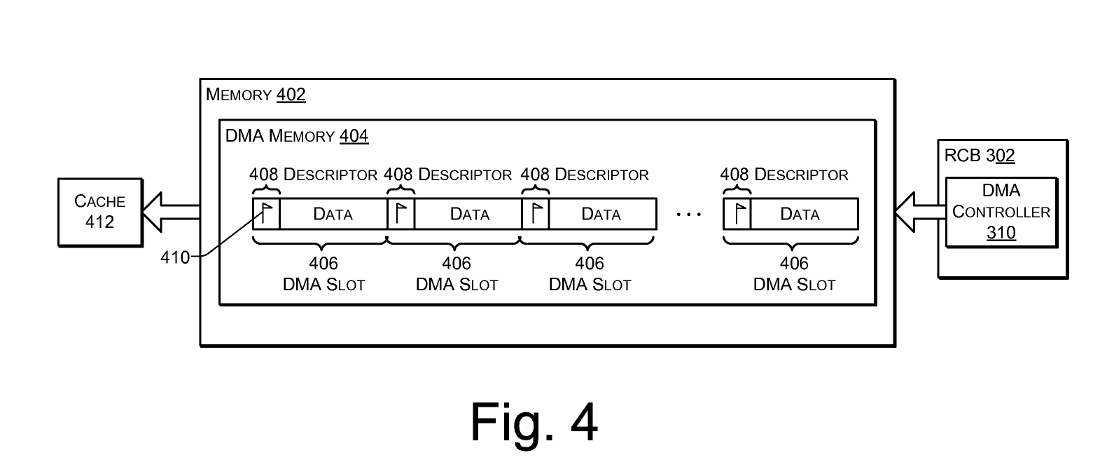

As illustrated in FIG. 4, implementations herein address this issue by using a smart-fetch strategy, thereby enabling implementations of the SDR to maintain cache coherency with DMA memory without drastically sacrificing throughput. FIG. 4 illustrates a memory 402 which may correspond to system memory 114, 204 discussed above, and which includes a portion set aside as DMA memory 404 that can be directly accessed by DMA controller 310 on the RCB 302 for storing digital samples as data. In some implementations, the SDR organizes DMA memory 404 into small slots 406, whose size is a multiple of the size of a cache line. Each slot 406 begins with a descriptor 408 that contains a flag 410 or other indicator to indicate whether the data has been processed. The RCB 302 sets the flag 410 after DMA controller 310 writes a full slot of data to DMA memory 404. The flag 410 is cleared after the processor processes all data in the corresponding slot in the cache 412, which may correspond to caches 106 and/or 108 described above. When the processor moves to a cache location corresponding to a new slot 406, the processor first reads the descriptor of the slot 406, causing a whole cache line to be filled. If the flag 410 is set (e.g., a value of “1”), the data just fetched is valid and the processor can continue processing the data. Otherwise, if the flag is not set (e.g., a value of “0”), the DMA controller on the RCB has not updated this slot 406 with new data, and the processor explicitly flushes the cache line and repeats reading the same location. The next read refills the cache line, loading the most recent data from DMA memory 404. Accordingly, the foregoing process ensures that the processor does not read an incorrect value from the cache 412. Furthermore, while an exemplary RCB 302 has been illustrated and described, it will be apparent to those of skill in the art in light of the disclosure here in that various other implementations of the RCB 302 also fall within the scope of the disclosure herein.

### SDR Software Implementations

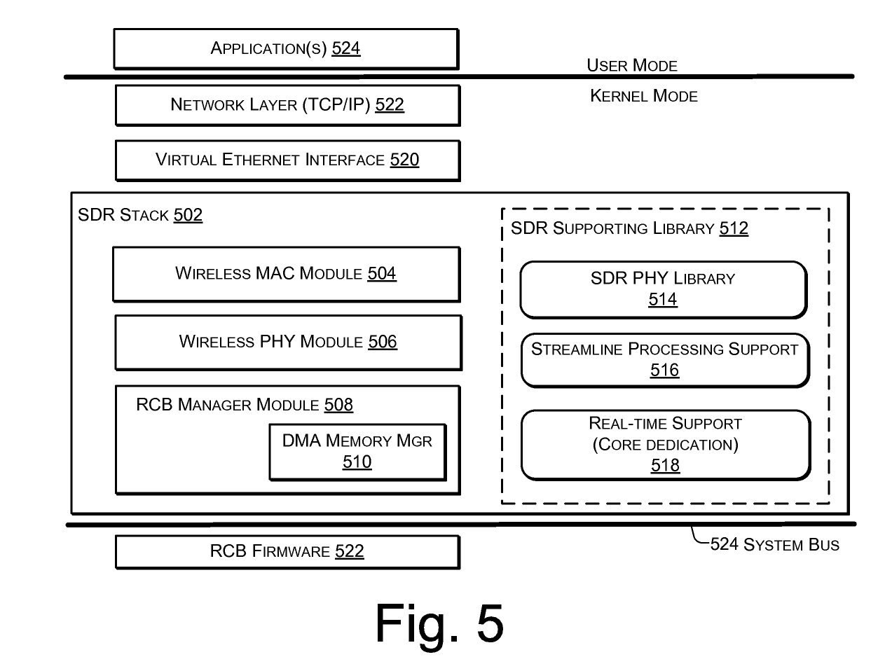

FIG. 5 illustrates an exemplary implementation of a software and logical architecture of the SDR herein showing a number of software components and a logical arrangement of the SDR. An SDR stack 502 includes a wireless MAC layer module 504, a wireless physical layer (PHY) module 506, and an RCB manager module 508 that includes a DMA memory manager 510, and that may correspond to RCB manager 218, discussed above. These components provide for system support, including driver framework, memory management, streamline processing, and the like. The role of the PHY module 506 is to convert information bits into a radio waveform, or vice versa. The role of the MAC layer module 504 is to coordinate transmissions in wireless networks to avoid collisions. Also included is an SDR supporting library 512 that includes an SDR physical layer (PHY) library 514, streamline processing support 516 and real-time support 518 (e.g., for ensuring core dedication, as discussed additionally below). The SDR stack software components may exist at various times in system memory, cache, and/or mass storage or other computer readable storage media, as is known in the art.

The software components in implementations of the SDR herein provide necessary system services and programming support for implementing various wireless PHY and MAC protocols in a general-purpose operating system, such as Windows® XP, Windows Vista®, Windows® 7, Linux®, Mac OS® X, or other suitable operating system. In addition to facilitating the interaction with the RCB, the implementations of the SDR stack 502 provide a set of techniques to greatly improve the performance of PHY and MAC processing on a general-purpose processor. To meet the processing and real-time requirements, these techniques make full use of various features in multi-core processor architectures, including the extensive use of lookup tables (LUTs), substantial data-parallelism with processor SIMD extensions, the efficient partitioning of streamlined processing over multiple cores, and exclusive dedication of cores for software radio tasks.

Implementations of the SDR software may be written in any suitable programming language(s). For example, in some implementations, the software may be written in C, with, additionally, some assembly language for performance-critical processing. Further, some implementations of the SDR stack 502 may be implemented as a network device driver on a general-purpose operating system. Thus, RCB manager module 508 functions as a driver in the operating system for operating and managing the RCB and may include a PCIe driver for enabling use of the PCIe system bus. The SDR stack 502 exposes a virtual Ethernet interface 520 to the upper TCP/IP layer 522 of the kernel side, thereby enabling the SDR to appear and function as a network device. Since any software radio implemented on the SDR herein can appear as a normal network device, all existing network applications 524 used by a user are able to execute and interact with the SDR in an unmodified form. Further, on the other end, the SDR stack logically interacts with RCB firmware 522 via the system bus 524, which may be a PCIe system bus, as discussed above.

In some implementations of the SDR herein, SDR PHY processing library 514 extensively exploits the use of look-up tables (LUTs) and SIMD instructions to optimize the performance of PHY algorithms. For example, more than half of the PHY algorithms can be replaced with LUTs. Some LUTs are straightforward pre-calculations, others require more sophisticated implementations to keep the LUT size small. For instance, in the soft-demapper example discussed below, the LUT size (e.g., 1.5 KB for 802.11a/g 54 Mbps modulation) can be greatly reduced by exploiting the symmetry of the algorithm. Further, in the exemplary WiFi implementation described below, the overall size of the LUTs used in 802.11a/g is around 200 KB and in 802.11b is around 310 KB, both of which fit comfortably within the L2 caches of conventional multi-core processors.

Further, as discussed above, some implementations use SIMD (Single Instruction Multiple Data) instructions, such as the SSE2 (Streaming SMID Extensions 2) instruction set designed for Intel CPUs for speeding parallel processing of large numbers of data points, such as when processing digital samples. Since the SSE registers are 128 bits wide while most PHY algorithms require only 8-bit or 16-bit fixed-point operations, one SSE instruction can perform 8 or 16 simultaneous calculations. SSE2 also has rich instruction support for flexible data permutations, and most PHY algorithms, e.g., Fast Fourier Transform (FFT), Finite Impulse Response (FIR) Filter and Viterbi decoder algorithms, can fit naturally into this SIMD model. For example, the implementations of the Viterbi decoder according to the SDR herein uses only 40 cycles to compute the branch metric and select the shortest path for each input. As a result, Viterbi implementations can handle 802.11a/g at 54 Mbps modulation using only one 2.66 GHz CPU core in a multi-core processor, whereas conventional designs had to rely on specialized hardware implementations.

Additionally, it should be noted that other brands of processor architectures, such processors available from AMD, and PowerPC® processors available from Apple Inc. of Cupertino, Calif., USA, have very similar SIMD models and instruction sets that can be similarly utilized. For example, AMD's Enhanced 3DNow!® processor includes an SSE instruction set plus a set of DSP (Digital Signal Processor) extensions. The optimization techniques described herein can be directly applied to these and other GPP architectures as well. An example of a functional block using SIMD instruction optimizations is discussed further below.

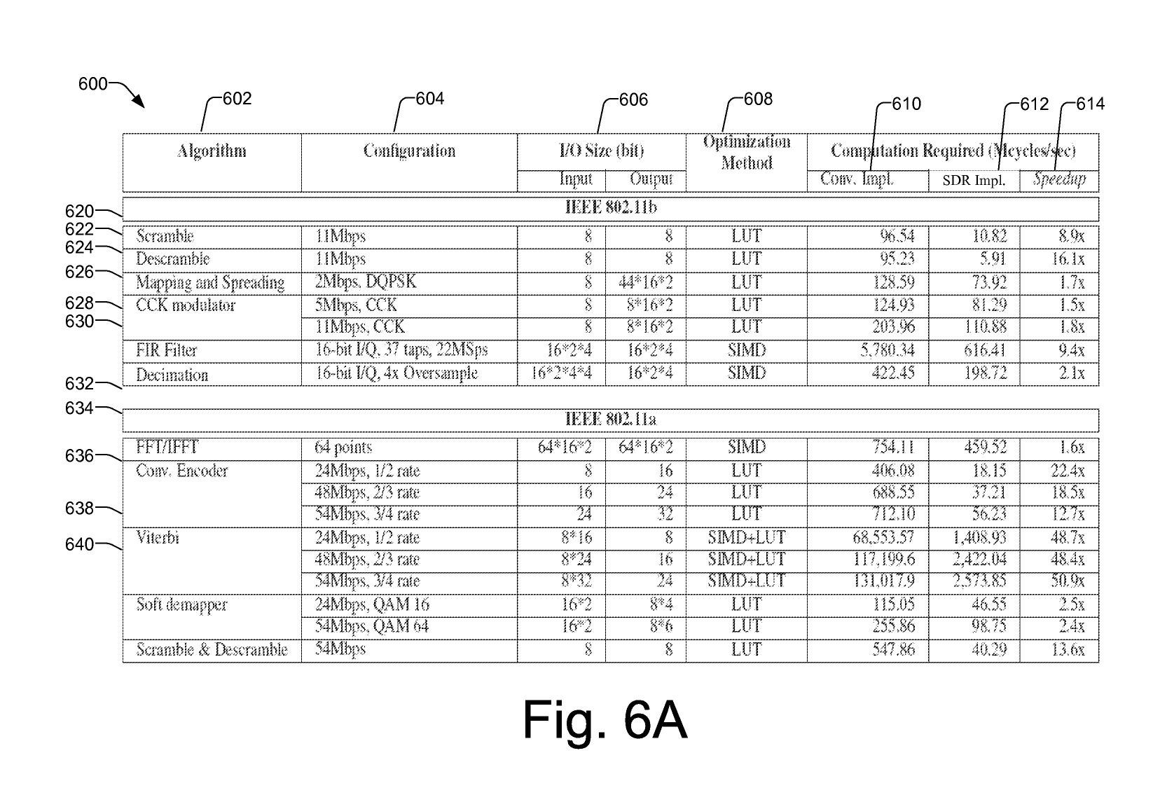

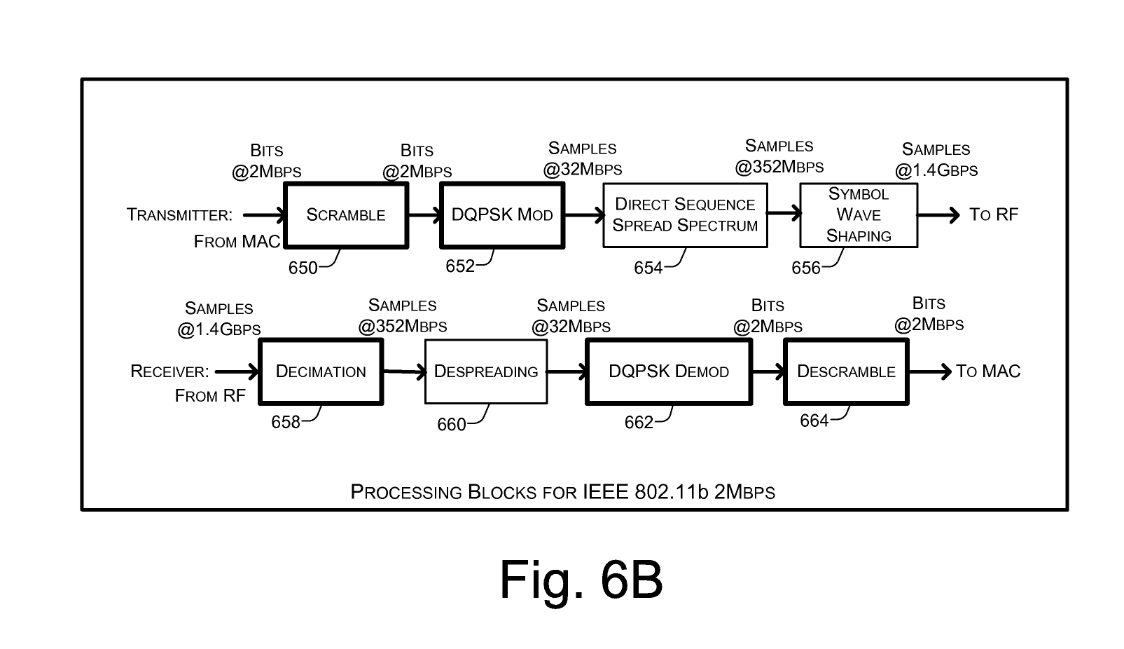

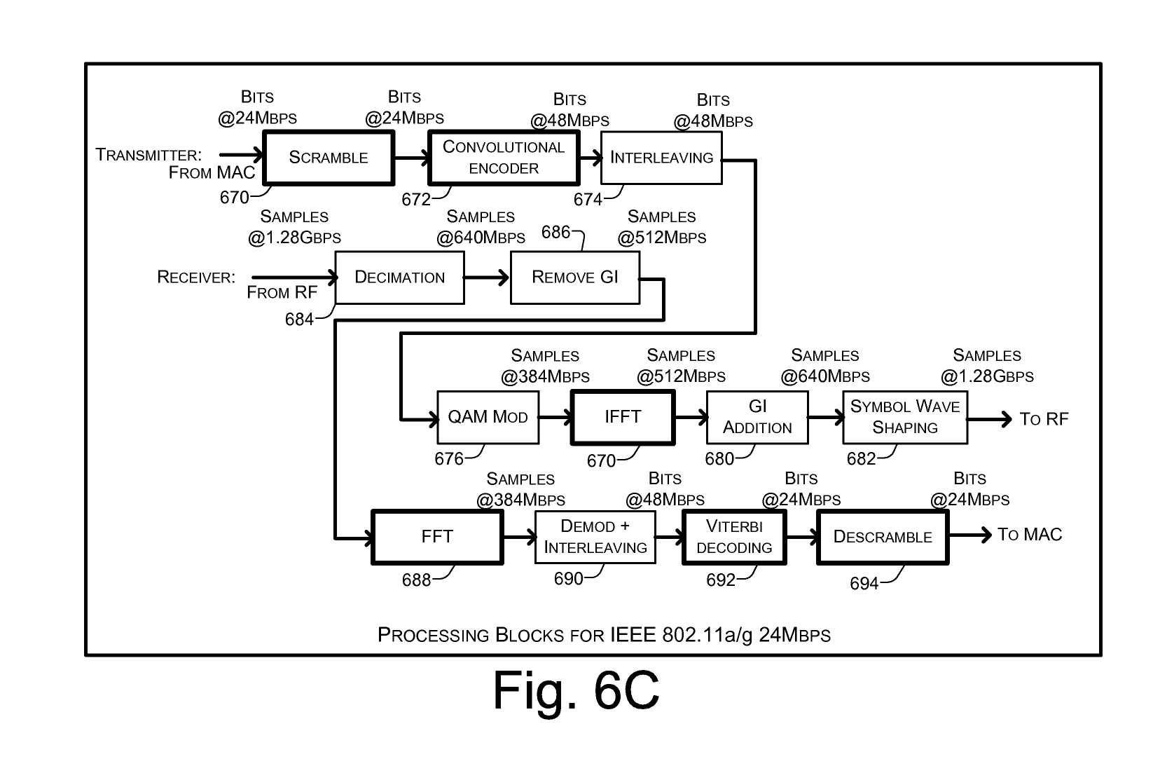

FIG. 6A illustrates an algorithm optimization table 600 that summarizes some PHY processing algorithms implemented in the SDR herein, together with the LUT and SIMD optimization techniques applied for improving the processing speed. The algorithm table 600 includes an algorithm identification column 602, a configuration column 604, and I/O size column 606, an optimization method column 608, number of computations required for a conventional implementation column 610, computations required for the SDR implementation 612, and the amount of speed up 614 gained by the optimization. For example, for the IEEE 802.11b standard, algorithms that maybe optimize using LUTs according to the SDR herein include the scramble algorithm 620, the descramble algorithm 622, the mapping and spreading algorithm 624, and the CCK (Complementary Code Keying) modulator algorithm 626, while algorithms that maybe optimized using SIMD extensions include the FIR filter 628, and the decimation algorithm 630. Additionally, for the IEEE 802.11a standard, algorithms that maybe optimized using SIMD extensions include the FFT/IFFT (Fast Fourier Transform/Inverse Fast Fourier Transform) algorithm 632, algorithms that may be optimized using LUTs according to the SDR herein include the convolutional encoder algorithm 634, the Viterbi algorithm 636, the soft demapper algorithm 638, and the scramble and descramble algorithms 640. Further, the Viterbi algorithm 636 may also be further optimized using SIMD extensions.

FIG. 6B illustrates an example of PHY operations for IEEE 802.11b at 2 Mbps, further showing examples of functional blocks that are optimized according to some implementations here, as discussed above with reference to FIG. 6A. The role of the PHY layer is to convert information bits into a radio waveform, or vice versa. As illustrated in FIG. 6B, at the transmitter side, the wireless PHY component first modulates the message (i.e., a packet or a MAC frame) into a time sequence of baseband signals. Baseband signals are then passed to the radio front end, where they are multiplied by a high frequency carrier and transmitted into the wireless channel. In the illustrated example, the data from the MAC goes to a scramble block 650, a DQPSK modulator block 652, a direct sequence spread spectrum block 654, a symbol wave shaping block 656, and then is passed to the RF front end. At the receiver side, the RF front end detects signals in the channel and extracts the baseband signal by removing the high-frequency carrier. The extracted baseband signal is then fed into the receiver's PHY layer to be demodulated into the original message. In the illustrated example, the signal from the RF front end is passed to a decimation block 658, a despreading block 660, a DQPSK demodulator block 662, a descramble block 664, and then to the MAC layer. Accordingly, advanced communication systems (e.g., IEEE 802.11a/b/g) contain multiple functional blocks in their PHY components. These functional blocks are pipelined with one another. Data is streamed through these blocks sequentially, but with different data types and sizes. For instance, as illustrated in FIG. 6B, different blocks may consume or produce different types of data at different rates arranged in small data blocks. For example, in 802.11b, as illustrated in FIG. 6B, the scrambler block 650 may consume and produce one bit, while DQPSK modulation block 652 maps each two-bit data block onto a complex symbol which uses two 16-bit numbers to represent the in-phase and quadrature (I/Q) components.

Each PHY block performs a fixed amount of computation on every transmitted or received bit. When the data rate is high, e.g., 11 Mbps for 802.11b and 54 Mbps for 802.11a/g, PHY processing blocks consume a significant amount of computational power. It is estimated that a direct implementation of 802.11b may require 10 Gops while 802.11a/g requires at least 40 Gops. These requirements are very demanding for software processing in GPPs.

PHY processing blocks directly operate on the digital waveforms after modulation on the transmitter side and before demodulation on the receiver side. Therefore, high-throughput interfaces are desired to connect these processing blocks as well as to connect the PHY with the radio front end. The required throughput linearly scales with the bandwidth of the baseband signal. For example, the channel bandwidth is 20 MHz in 802.11a. This requires a data rate of at least 20 Million complex samples per second to represent the waveform. These complex samples normally require 16-bit quantization for both I and Q components to provide sufficient fidelity, translating into 32 bits per sample, or 640 Mbps for the full 20 MHz channel. Over-sampling, a technique widely used for better performance, doubles the requirement to 1.28 Gbps to move data between the RF frond-end and PHY blocks for one 802.11a channel.

As discussed above with reference to FIG. 6A, in order to speed up processing of some blocks, implementations herein optimize certain functional blocks by using LUT and SIMD optimization techniques discussed above. In the illustrated example of FIG. 6B, as shown in bold, scramble block 650, descramble block 664, and DQPSK Modulator and DQPSK demodulator blocks 624 are optimized using LUTs stored in cache on the processor, corresponding to scramble algorithm 620, descramble algorithm 622, and mapping and spreading algorithm 624 discussed above with respect to FIG. 6A. Further, decimation block 658 is optimized using SIMD processor extensions corresponding to decimation algorithm 630 discussed above with respect to FIG. 6A.

Similarly, FIG. 6C illustrates an example of PHY operations for IEEE 802.11b at 2 Mbps, showing in bold which functional blocks are optimized according to some implementations here, as discussed above with reference to FIG. 6A. On the transmitter side, the data received from the MAC layer is passed to a scramble block 670, convolutional encoder block 672, an interleaving block 674, a QAM modulator block 676, an IFFT block 670, a GI addition block 680, a symbol wave shaping block 682, and then is passed to the RF front end. On the receiver side, the signal from the RF front end is passed to a decimation block 684, a remove GI block 686, an FFT block 688, a demodulating and interleaving block 690, a Viterbi decoding block 692, a descramble block 694, and then to the MAC processing. In order to speed up processing of some blocks, implementations herein optimize certain blocks by using LUT and SIMD optimization techniques discussed above with respect to FIG. 6A. In the illustrated example of FIG. 6C, scramble block 670 and descramble block 694 are optimized using LUTs stored in cache on the processor corresponding to scramble and descramble algorithm 640 discussed above; FFT Block 688 and IFFT block 670 are optimized using SIMD processor extensions corresponding to FFT/IFFT algorithm 632 discussed above; convolutional encoder block 672 is optimized using LUTs corresponding to convolutional encoder algorithm 634 discussed above; and Viterbi decoding block 692 is optimized using both LUTs and SIMD processor extensions corresponding to Viterbi algorithm 636 discussed above. Furthermore, in addition to the optimizations illustrated in this example, other optimization opportunities may be apparent to those of skill in the art in light of the disclosure herein.

### SIMD Example Based on FIR Filter

The following provides an example of how to use SSE instructions to optimize the implementation of a FIR (Finite Impulse Response) filter in implementations of the SDR herein, corresponding to FIR filter algorithm 628 discussed above with respect to FIG. 6A, with it being understood that the optimizations of the other algorithms, such as decimation 630, may be similarly implemented. FIR filters are widely used in various PHY layers. An n-tap FIR filter is defined as follows:

y[t]=Σₖ₌₀ⁿ⁻¹cₖ*x[t−k],

where x[.] are the input samples, y[.] are the output samples, and cₖ are the filter coefficients. With SIMD instructions, it is possible to process multiple samples at the same time. For example, Intel SSE supports a 128-bit packed vector and each FIR sample takes 16 bits. Therefore, it is possible to perform m=8 calculations simultaneously. To facilitate SSE processing, the data layout in memory should be carefully designed.

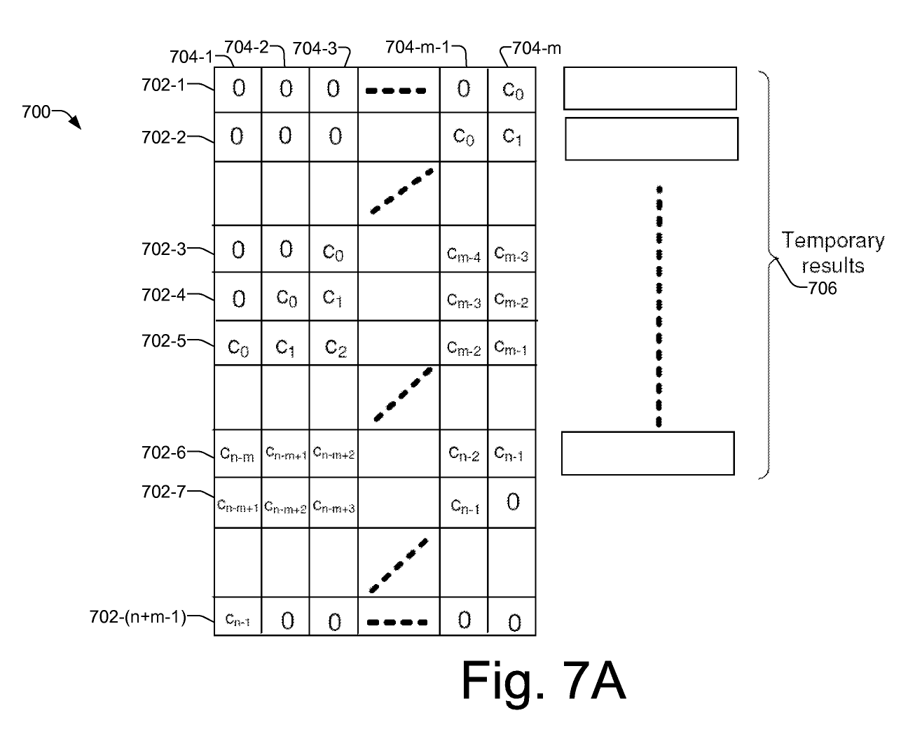

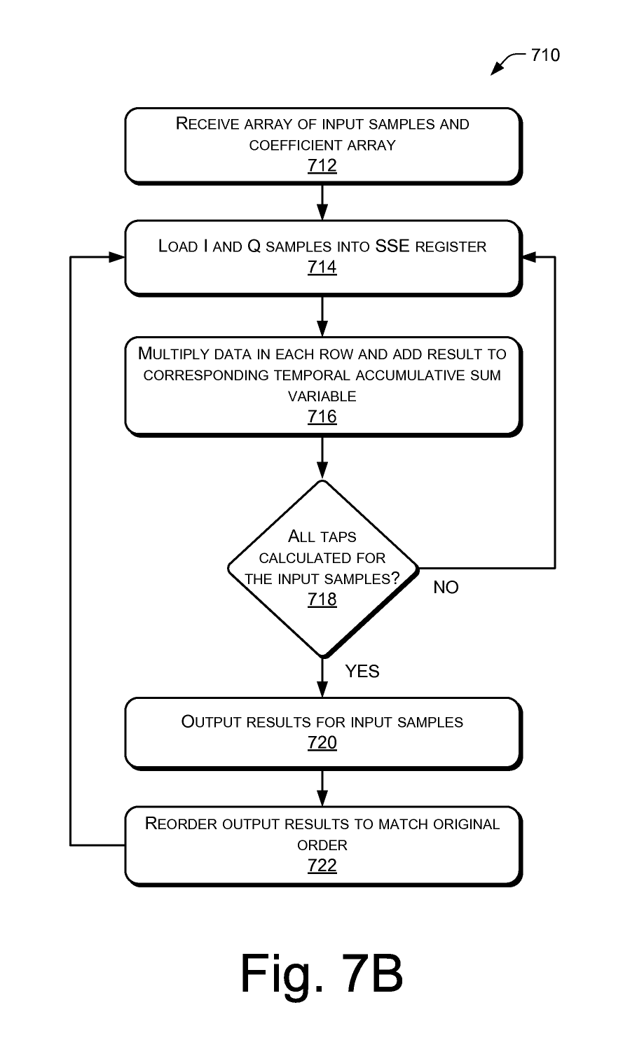

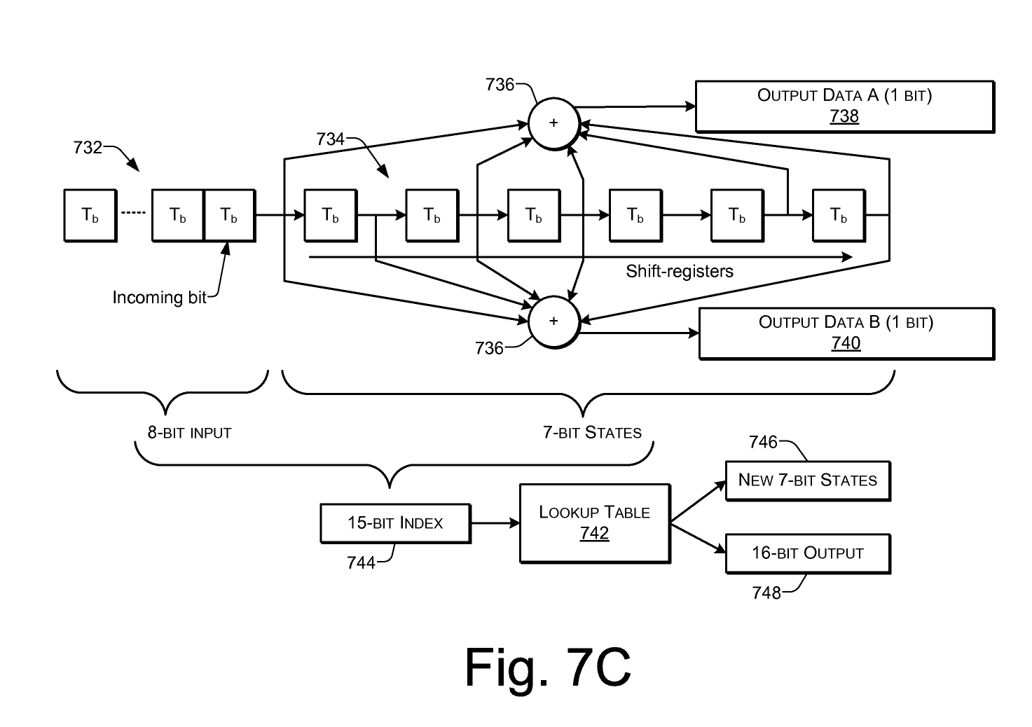

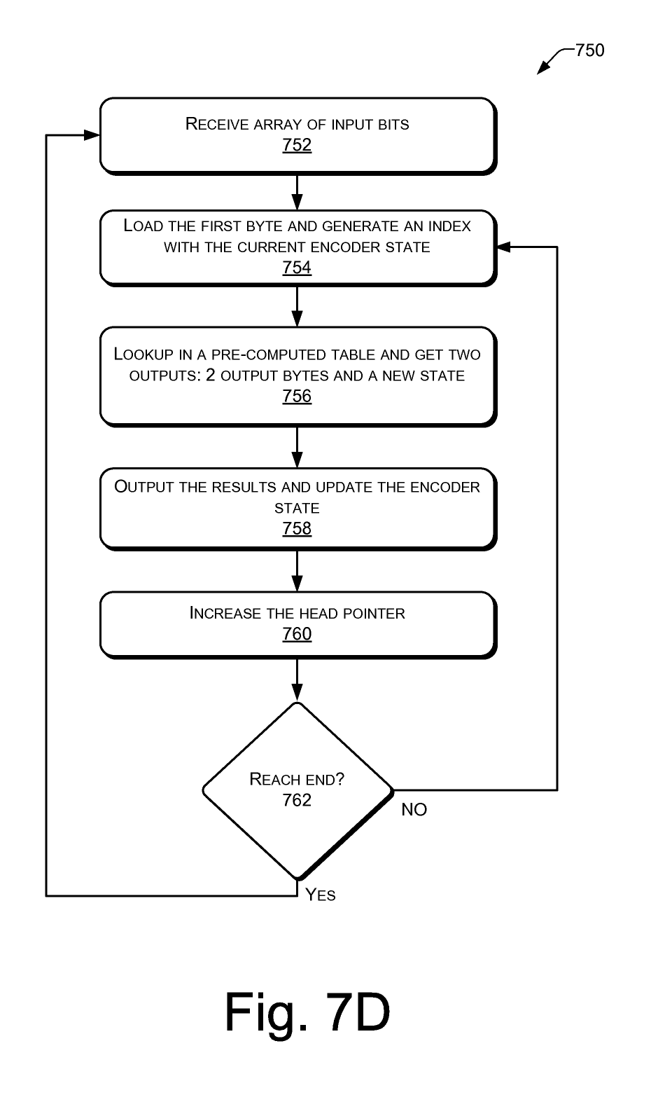

FIG. 7A illustrates a memory layout 700 of the FIR coefficients according to implementations herein. Each row 702-1, . . . , 702-(n+m−1) forms a packed-vector containing m components for SIMD operations. The coefficient vector of the FIR filter is replicated in each column 704-1, . . . , 704-m in a zigzag layout. Thus, the total number of rows is (n+m−1). There are also n temporary variables 706 containing the accumulated sum up to each FIR tap for each sample.

FIG. 7B illustrates a flowchart of an exemplary process for performing the SIMD operations of the FIR filter executed by the PHY layer of the SDR stack on a core of a multi-core processor. The process receives an array of input samples and a coefficient array, and outputs the filtered samples in an output sample buffer.

At block 712, the process receives an array of input samples and a coefficient array. The input samples contain two separate sample streams, with the even and odd indexed samples representing the I and Q samples, respectively. The coefficient array is arranged similarly to the layout of FIG. 7A, but with two sets of FIR coefficients for I and Q samples, respectively.

At block 714, for each iteration, four I and four Q samples are loaded into an SSE register.

At block 716, the process multiplies the data in each row and adds the result to the corresponding temporal accumulative sum variable.

At block 718, the process determines whether all the samples in the array of input samples have been processed to calculate all taps. If not, the process returns to block 714 to load more I and Q samples into the SSE registers.

At block 720, the results are output for the input samples when all taps have been calculated for the input samples. When the input sample stream is long, there are nm samples in the pipeline and m outputs are generated in each iteration. Note that the output samples may not be in the same order as the input samples. For example, some algorithms do not always require the output to have exactly the same order as the input.

Accordingly, at block 722, the output results can be reordered to the original order. This can be accomplished using a few shuffle instructions to place the output samples in original order, if needed. The process then returns to block 714 to continue to receive the stream of input samples from block 712 until all samples have been processed. Thus, while the foregoing provides a specific example of SIMD processing for speeding processing of digital samples in the SDR herein, it will be apparent to those of skill in the art in light of the disclosure herein that this process can be applied to optimize other SDR algorithms on one or more cores of a multi-core processor according to the implementations herein, such as the examples discussed above with respect to FIGS. 6A-6C.

### High-Performance SDR Processing

Implementations of the SDR herein achieve high-performance SDR processing using software techniques that include efficient physical layer processing, multi-core streamline processing, and real-time support, each of which is described additionally below.

### Efficient PHY Processing

In a memory-for-computation tradeoff, implementations of the SDR herein rely upon the large-capacity, high-speed cache memory in multi-core processors to accelerate PHY processing using pre-calculated LUTs stored in the PHY library. Contemporary processor architectures, such as Intel Core 2, usually have at least several megabytes of onboard cache with a low (e.g., 10˜20 cycles) access latency. If LUTs are pre-calculated for a large portion of PHY algorithms and stored in the onboard cache for a corresponding core, this can greatly reduce the computational requirement for online processing and speed up overall processing time.

For example, the soft demapper algorithm 638 used in demodulation in the IEEE 802.11a standard needs to calculate the confidence level of each bit contained in an incoming symbol. This task involves rather complex computations proportional to the modulation density. More precisely, the soft demapper algorithm 638 conducts an extensive search for all modulation points in a constellation graph and calculates a ratio between the minimum of Euclidean distances to all points representing one and the minimum of distances to all points representing zero. In implementations of the SDR herein, the confidence levels for all possible incoming symbols are pre-calculated based on their I and Q values, and LUTs are built to directly map the input symbol to confidence level. Such LUTs need not be large. For example, in 802.11a/g with a 54 Mbps modulation rate (64-QAM), the size of the LUT for the soft demapper 638 is about 1.5 KB.

FIGS. 7C-7D illustrate an example of SDR processing using an LUT according to some implementations herein. FIG. 7C illustrates how processing of a functional block can be speeded up by using a precomputed LUT instead of performing the actual processing of the bits using the processing algorithm. For example, when there are a finite combination of input bits and corresponding output data, then an LUT can be precomputed to be used to quickly match the input with corresponding output. In FIG. 7C, an array of input bits of a digital sample is received as a bit stream for processing, such as in one of the functional processing blocks described above with reference to FIGS. 6A-6C that is able to use an LUT to speed processing (e.g., the convolutional encoder algorithm). The convolutional encoder normally works in the following way. The convolutional encoder algorithm maintains seven shift registers 734, which form the state of the encoder. For each incoming bit, the algorithm 736 selects several bits in the shift registers 734 and performs eXclusive OR (XOR) operations on them, then two encoded output bits are generated as output data A 738 and output data B 740. Then, the shift registers 734 shift right and the input bit is put into the left-most register. Conventionally, to process one bit, it takes eight operations to compute the outputs (i.e., to produce a 2-bit output from a 1-bit input). However, as discussed above, the processing can avoid the actual processing of the algorithm 736 by using LUT 742. Thus, instead of processing one bit at a time, an 8-bit data can be treated as a single input for processing using the LUT. The 8-bit input and the 7-bit states of the current state can be combined to generate a 15-bit index 744. The 15-bit index is then located in the LUT 742, and the corresponding precomputed new 7-bit states 746 and a 16-bit output 748 are determined from the LUT 742 instead of processing each bit individually by processing the algorithm 736. Thus, it may be seen that if all possible 15-bit indices and their corresponding output 7-bit states 746 and 16-bit outputs 748 are precomputed and stored in LUT 742, the actual processing time for the SDR sample stream can be greatly expedited (i.e., encoding of eight bits can be carried out using a single lookup operation).

FIG. 7D illustrates an exemplary process 750 that may be executed by the PHY layer of the SDR stack on a core of a multi-core processor by using an LUT instead of processing the bit stream using a conventional algorithm, such as the convolutional encoder algorithm. Other algorithms in the SDR pipeline may similarly be expedited by the use of precomputed LUTs, as discussed above with reference to FIGS. 6A-6C.

At block 752, an array of input sample bits is received for processing as a stream of bits.

At block 754, the process loads the first byte (8 bits) and generates an index with the current encoder state (the 7 bit state).

At block 756, the process accesses the precomputed LUT using the generated index and locates two values: two output bytes (i.e., a 16-bit output) and a 7-bit new state.

At block 758, the two output bytes are passed as output to the next processing block in the SDR processing stream, e.g., as illustrated in FIGS. 6B or 6C, and the 7-bit new state is used for processing the next byte in the sample bit stream.

At block 760, the head pointer is increased to encompass the next eight bits.

At block 762, the process determines whether the end of the bit array has been reached. If not, the process returns to block 754 to process the next byte; if so, the process goes to block 752 to receive the next array of input bits.

As discussed above with reference to FIGS. 6A-6C, more than half of the common PHY algorithms of the IEEE 802.11 standards can be supplanted with LUTs, thereby resulting in a processing time speedup 614 from between approximately 1.5× to 50× (see, e.g., FIG. 6A). Since the size of each LUT is sufficiently small, the sum of all LUTs in a processing path can easily fit in the L2 caches of typical multi-core processor cores. Accordingly, when combined with core dedication, as discussed below, the possibility of cache collisions is very small. As a result, the LUTs of the implementations herein are almost always located in onboard caches during PHY processing. Additionally, while an exemplary implementation has been illustrated in FIGS. 7C-7D to describe how an LUT can be used to speed SDR processing, it should be understood that the other algorithms discussed above as being able to be expedited with LUTs can be similarly processed using precomputed LUTs.

Further, in order to accelerate PHY processing with data-level parallelism, implementations of the SDR herein also use the SIMD processor extensions discussed above, such as SSE, SEE2, 3DNow!®, and AltiVec® provided in conventional multi-core processors. Although these extensions were originally designed for multimedia and graphics applications, the extensions also match the needs of wireless signal processing very well because many PHY algorithms have fixed computation structures that can easily map to large vector operations. Measurements show that such SIMD extensions substantially speed up PHY processing in implementations of the SDR herein.

### Multi-Core Streamline Processing

Even with the above optimizations, a single CPU core may not have sufficient processing capacity to meet the processing requirements of high-speed wireless communication technologies. As a result, implementations of the SDR herein are able to use more than one core in a multi-core processor for PHY processing. In some implementations, the multi-core technique is also scalable to provide for compatibility with increasingly more complex signal processing algorithms as wireless technologies progress.

As discussed above, such as with respect to FIGS. 6B and 6C, physical layer processing typically contains a number of functional blocks or distinct stages in a pipeline. These blocks differ in processing speed and in input/output data rates and units. A block is only ready to execute when the block has received sufficient input data from the preceding block. Therefore, a key issue is how to schedule a functional block on multiple cores when the block is ready for processing.

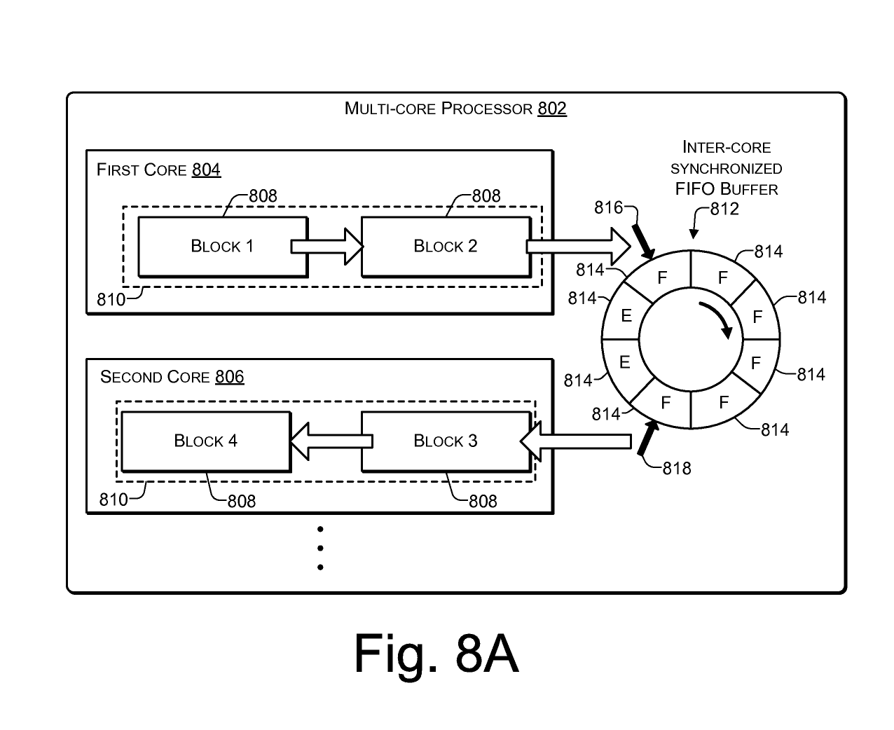

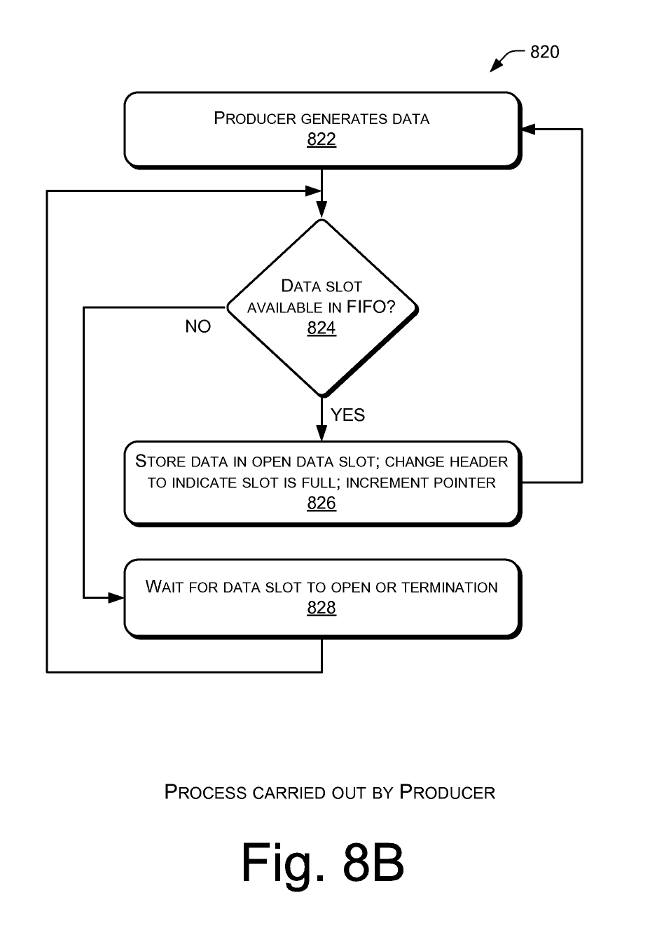

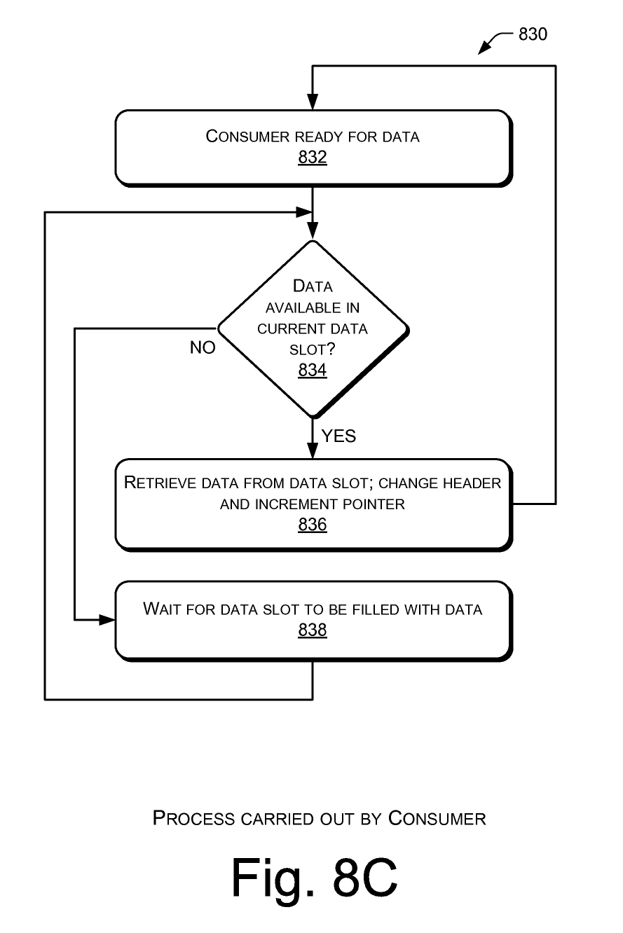

FIG. 8A illustrates an exemplary implementation for processing data in functional blocks on different cores in a multi-core processor 802, which may correspond to multi-core processors 102, 202 discussed above. For example a first core 804 and a second core 806 may be used to process the functional blocks discussed above with reference to FIGS. 6A-6C. First core 804 may be located on the same multi-core processor as second core 806, or the cores 804, 806 may be located on separate processors.

In FIG. 8A, the first core 804 and the second core 806 process a plurality of functional blocks 808 using a static scheduling scheme. This implementation is based on the observation that the schedule of each block in a PHY processing pipeline is actually static, i.e., the processing pattern of previous blocks can determine whether a subsequent block is ready or not. Implementations of the SDR herein can thus partition the whole PHY processing pipeline into several sub-pipelines 810 and statically assign the sub-pipelines 810 to different cores 804, 806. Within one sub-pipeline 810, when a first block 808 has accumulated enough data for the next block to be ready, the first block explicitly schedules the next block. Adjacent sub-pipelines from different blocks are connected with a synchronized FIFO 812 that manages the delivery of data between the sub-pipelines 810. For example, the synchronized FIFO 812 may be established in one of caches 106, 108 discussed above with respect to FIG. 1. Thus, implementations herein allow different PHY processing blocks 808 to streamline across multiple cores 804, 806 while communicating with one another through one or more shared memory synchronized FIFO queues. For example, if two blocks 808 (e.g., Block 2 and Block 3 of FIG. 8A) are running on different cores 804, 806, their access to the shared FIFO 812 must be synchronized. The traditional implementation of a synchronized FIFO uses a counter to synchronize the writer (producer) and reader (consumer) in what is referred to as a counter-based FIFO (CBFIFO).

However, this counter is shared by two processor cores, and every write to the variable by one core will cause a cache miss on the other core. Since both the producer and consumer modify this variable, two cache misses are unavoidable for each datum. It is also quite common to have very fine data granularity in PHY (e.g., 4-16 bytes as summarized in FIG. 6 discussed above). Therefore, such cache misses will result in significant overhead when synchronization has to be performed very frequently (e.g., once per microsecond) for such small pieces of data. In implementations of the SDR herein, an inter-core synchronized circular FIFO buffer 812 is implemented that does not use a shared synchronization variable. Instead of having a shared variable, implementations herein augment each data slot 814 in the synchronized FIFO buffer 812 with a header that indicates whether the slot is empty or full (i.e., “E” or “F”). Furthermore, each data slot 814 is padded to be a size that is equal to a multiple of a cache line size. Thus, the consumer is always chasing the producer in the circular buffer 812 for filled slots, as outlined in the following pseudo code:

// Producer:
void write_fifo ( DATA_TYPE data ) {
while (q[w_tail].flag>0); // spin wait
q[w_tail].data = data;
q[w_tail].flag = 1; // occupied
w_tail = (w_tail+1) % q_size;
}
// Consumer:
void read_fifo ( DATA_TYPE * pdata ) {
while (q[r_head].flag==0); // spin
*data = q[r_head].data;
q[r_head].flag = 0; // release
r_head = (r_head + 1) % q_size;
}

This chasing-pointer FIFO (CPFIFO) largely mitigates the overhead even for very fine-grained synchronization through implementation of a producer pointer 816 and a consumer pointer 818. For example, if the speed of the producer (e.g., Block 2 on first core 804) and consumer (e.g., Block 3 on second core 806) is the same, and the two pointers are separated by a particular offset (e.g., two cache lines in the Intel architecture), no cache miss will occur during synchronized streaming since the local cache will pre-fetch the following slots before the actual access. If the producer and the consumer have different processing speeds, e.g., the consumer (reader) is faster than the producer (writer), then eventually the consumer will wait for the producer to release a slot. In this case, each time the producer writes to a slot, the write will cause a cache miss at the consumer. However, the producer will not suffer a miss since the next free slot will be prefetched into its local cache. Further, the cache misses experienced by the consumer will not cause significant impact on the overall performance of the streamline processing since the consumer is not the bottleneck element. Additionally, while the FIFO buffer 812 is illustrated as being circular, it is understood in the art that this is only for illustration purposes and that the buffer is actually a logical location in the cache memory and that the locations of the empty and full data slots in the buffer 812 are actually maintained by the relative locations of the pointers 816, 818.

FIG. 8B illustrates a flowchart of an exemplary process 820 carried out by the producer (e.g., first core 804) for processing digital samples using the synchronized FIFO buffer 812. The process is executed by the PHY module of the SDR stack using multiple cores of a multi-core processor 802.

At block 822, the producer generates data. For example, first core 804 processes data in functional blocks 808 (e.g., Block 1 and Block 2) to generate the data.

At block 822, the producer determines whether an available data slot is open in the FIFO buffer 812 by referring to the data slot to which the producer pointer 816 is currently pointing and checking the header for that data slot.

At block 826, if the header indicates that the current slot is empty the producer stores the generated data in the empty data slot, and increments the producer pointer 816 by one data slot.

At block 828, if the header indicates that the data slot to which the producer pointer is currently pointing is full, the producer waits for an empty data slot to become available. A termination condition can also be set by a user when it is desired to stop the process.

FIG. 8C illustrates a flowchart of an exemplary process 830 carried out by the consumer (e.g., second core 806) for processing digital samples using the synchronized FIFO buffer 812. The process is executed by the PHY module of the SDR stack using multiple cores of a multi-core processor 802.

At block 832, the consumer is ready to receive and process data. For example, in the pipeline of Block 3 and Block 4 in second core 806, data may have been passed from Block 3 to Block 4, and Block 3 is now ready for more data.

At block 834, the consumer checks the data slot to which the consumer pointer 818 is currently pointing to determine if the slot contains available data by checking the header to determine whether the header indicates that the slot is full or empty.

At block 836, when the slot contains data, the consumer takes the data from the data slot, thereby opening the data slot and changing the header of the data slot to indicate that the data slot is now empty. The consumer also increments the consumer pointer to the next data slot.

At block 838, if no data is available in the current data slot, the consumer continues to check the data slot and waits until the data slot is filled with data.

### Real-Time Support

SDR processing is a time-critical task that requires strict guarantees of computational resources and hard real-time deadlines. For example, in the 802.11 protocols, the wireless channel is a resource shared by all transceivers operating on the same spectrum. Thus, because simultaneously transmitting neighbors may interfere with each other, various MAC protocols have been developed to coordinate transmissions in wireless networks to avoid collisions.

Further, most modern MAC protocols, such as 802.11, require timely responses to critical events. For example, 802.11 uses a CSMA (Carrier-Sense Multiple Access) MAC protocol to coordinate transmissions. Transmitters are required to sense the channel before starting their transmission, and channel access is only allowed when no energy is sensed, i.e., the channel is free. The latency between sense and access should be as small as possible. Otherwise, the sensing result could be outdated and inaccurate, resulting in a collision. Another example is the link-layer retransmission mechanisms in wireless protocols, which may require an immediate acknowledgement (ACK) to be returned in a limited time window. Commercial standards like IEEE 802.11 mandate a response latency within tens of microseconds, which is challenging to achieve in software on a general-purpose processor running a general purpose OS.

Thus, as an alternative to relying upon the full generality of real-time operating systems, implementations herein obtain real-time guarantees by dedicating one or more processor cores to SDR processing in a multi-core processing system. Thus, because one or more cores are dedicated to the SDR, implementations herein guarantee sufficient computational resources, without being affected by other concurrent tasks in the system.

For example, wireless communications often require the PHY to constantly monitor the channel for incoming signals. Therefore, the PHY processing may need to be active all the times. It is desirable to schedule this monitoring task to operate continually on the same core to minimize overhead, such as cache misses or TLB flushes. Furthermore, isolating applications into different cores can result in better performance as compared to symmetric scheduling, since an effective use of cache resources and a reduction in locks can outweigh dedicating cores. Moreover, a core dedication mechanism is much easier to implement than a real-time scheduler, sometimes even without modifying an OS kernel. One example of a method for achieving core dedication according to implementations of the SDR herein is raising the priority of a kernel thread so that the kernel thread is pinned on a particular core and runs exclusively on that core until termination.

Implementations of the SDR herein use exclusive threads (i.e., “ethreads”) to dedicate cores for real-time SDR tasks. The ethreads can be implemented without any modification to the kernel code. For example, an ethread can be implemented as a kernel-mode thread, and thereby exploit the processor affiliation that is commonly supported in conventional operating systems to provide control regarding on which core the kernel mode thread runs. Once the OS has scheduled the ethread on a specified physical core, the OS raises the priority and/or the IRQL (interrupt request level) on the thread to a level as high as the kernel scheduler, e.g., dispatch level in Windows®. Thus, the ethread takes control of the core and prevents itself from being preempted by other threads by raising the interrupt request level.

Running at such an IRQL, however, does not prevent the core from responding to hardware interrupts. Therefore, the interrupt affiliations of all devices attached to the host are also constrained. For example, if an ethread is running on a particular core, all interrupt handlers for installed devices are removed from the core, thus preventing the core from being interrupted by hardware. Furthermore, to ensure the correct operation of the computing device and operating system, implementations of the SDR herein always ensure core zero is able to respond to all hardware interrupts. Consequently, implementations of the SDR herein only allow ethreads to run on cores whose ID is greater than zero.

### Exemplary Implementations

Exemplary implementations of the SDR herein include a fully functional WiFi transceiver on the SDR platform as an exemplary WiFi implementation. The exemplary WiFi implementation SDR stack supports all IEEE 802.11a/b/g modulations and can communicate seamlessly with commercial WiFi network cards. For instance, implementations of high-speed wireless protocols on general-purpose computing device architectures must overcome a number of challenges that stem from existing hardware interfaces and software architectures. First, transferring high-fidelity digital waveform samples into system memory for processing requires very high bus throughput. Conventional software radio platforms use USB 2.0 or Gigabit Ethernet, which cannot satisfy this requirement for sustaining high-speed wireless protocols. Second, physical layer (PHY) signal processing has very high computational requirements for generating information bits from waveforms, and vice versa, particularly at high modulation rates. Lastly, wireless PHY and media access control (MAC) protocols have low-latency real-time deadlines that must be met for correct operation. For example, the 802.11 MAC protocol requires precise timing control and ACK response latency on the order of tens of microseconds. Existing software architectures on the general-purpose computing devices cannot consistently meet this timing requirement.

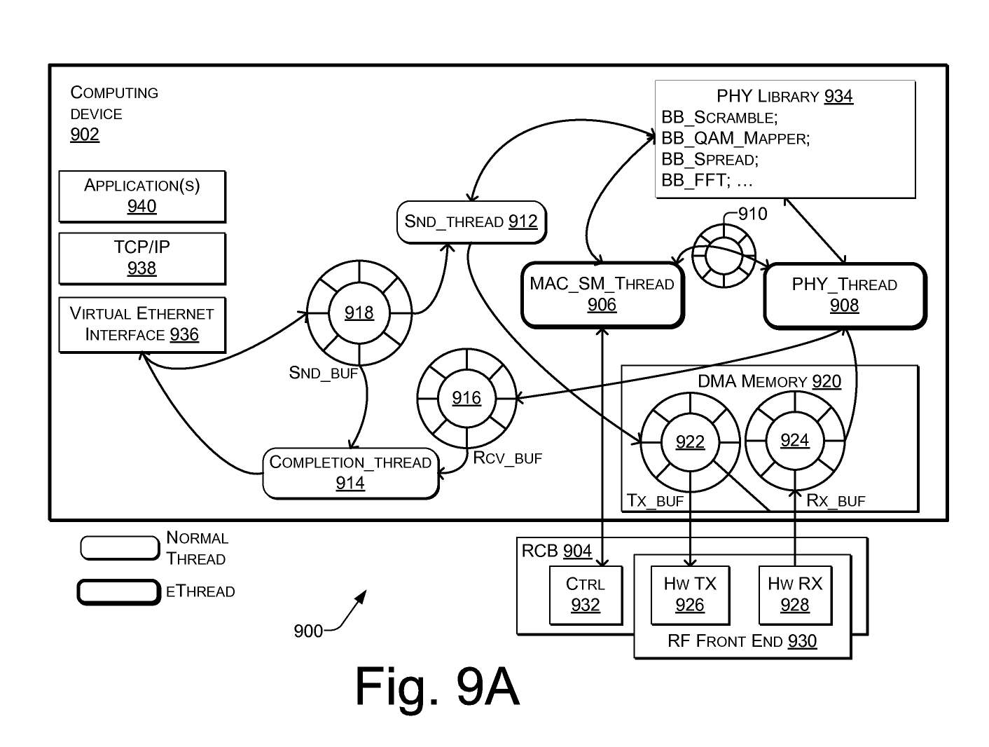

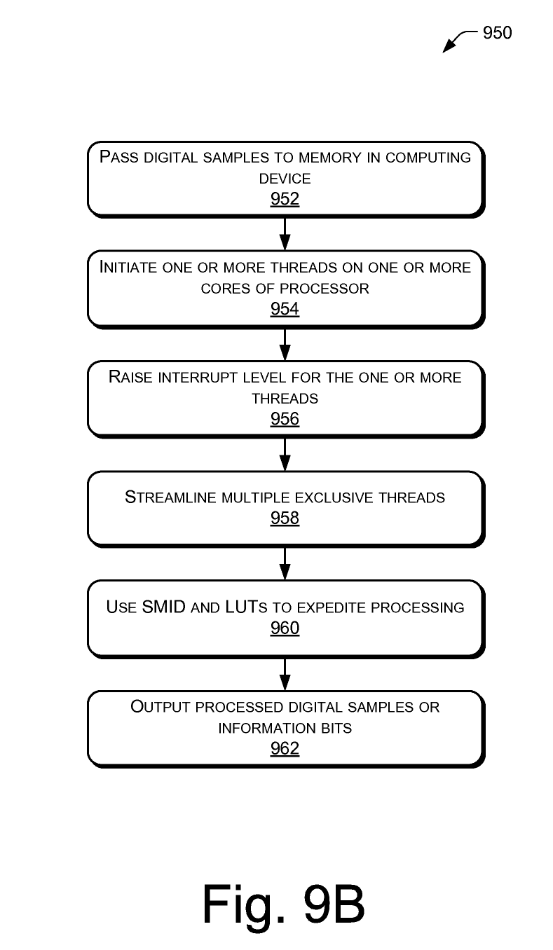

FIG. 9A illustrates an exemplary WiFi implementation 900 of the SDR herein implemented on hardware, such as a computing device 902, having a multi-core processor as described above with reference to FIGS. 1 and 2, and coupled to an RCB 904 corresponding to RCBs 116, 214, and/or 302. In the illustrated implementation, the MAC state machine (SM) is implemented as an ethread 906 by raising the priority of a kernel thread so that the kernel thread is pinned on a particular core and runs exclusively on that core until termination.

Since a radio according to the 802.11 standard is a half-duplex radio, the demodulation components of the PHY can run directly within a MAC SM thread. Furthermore, if a single core is insufficient for all PHY processing (e.g., as may be the case with 802.11a/g), the PHY processing can be partitioned across two ethreads comprising MAC_SM thread 906 and a PHY_Thread 908. These two ethreads 906, 908 are streamlined using a synchronized CPFIFO 910, as discussed above with respect to FIGS. 8A-8C. An additional thread, Snd_thread 912, modulates the outgoing frames into waveform samples in the background. As discussed above, these modulated waveforms can be pre-stored in the RCB's memory to facilitate speedy transmission. Further, a Completion_thread 914 monitors a receive buffer, Rcv_buf 916 and notifies upper software layers of any correctly received frames. The completion thread 914 also cleans up Rcv_buf 916 and a send buffer, Snd_buf 918 after they are used. Because the functions of the Completion_thread 914 and the Snd_thread 912 do not require the same high performance and low latency of the PHY ethreads 906, 908, these other threads are not implemented as ethreads, and can be run on any available core.

In the illustrated example, DMA memory 920 includes a transmitter buffer TX_buf 922 and a receiver buffer RX_buf 924 for storing digital samples for transmission and reception on transmitter hardware 926 and receiver hardware 928, respectively, on the RF front end 930 as discussed above, such as with respect to FIG. 4. Furthermore, RCB 904 includes control modules 932, such as the DMA controller, bus controller, memory controller, and RF controller described above with respect to FIG. 4, and collectively represented as Ctrl 924, which exchange commands with MAC_SM_Thread 906 for ensuring proper interaction between RCB 904 and computing device 902. During streamline processing, MAC_SM thread 906 and PHY thread 908 access the PHY library 934 for accessing LUTs and SIMD instructions for carrying out optimized PHY processing, as discussed above with respect to FIGS. 6A-6C and 7A-7B. The processed digital samples are delivered to the receive buffer 916, are then presented via the completion thread 914 to virtual Ethernet interface 936, thereby to the TCP/IP layer 938, and thus, to one or more applications 940 also running on one or more cores of computing device 902.

FIG. 9B illustrates an exemplary process 950 that may be executed using one or more cores of a multi-core processor for exclusively performing SDR processing on the one or more cores.

At block 952, digital samples are passed from the RCB to the memory in the computing device. The digital samples are received from the RF front end by the RCB and then may be passed to the memory in the computing device using direct memory access (DMA), or the like. The passing of the digital samples to the memory in the computing device may be controlled by a DMA controller on the RCB, and the DMA may also temporarily store the digital samples on the RCB in a buffer or onboard memory.

At block 954, threads may be initiated on one or more cores of the multi-core processor for performing SDR processing, such as PHY and MAC processing.

At block 956, the interrupt request level for the one or more cores may be raised to ensure that the threads are not interrupted so that the cores are able to exclusively perform SDR processing of the digital samples. Further, the interrupt handler for the one or more cores may also be removed to prevent hardware interrupts as well.

At block 958, when multiple threads operate on different cores, the processing between cores may be streamlined as discussed above using a synchronized FIFO between the cores.

At block 960, SMID and LUTs may be used where applicable to expedite the SDR processing of the digital samples.

At block 962, the processed digital samples are output for use, such as by an application on the computing device. Further, while the foregoing process illustrates exclusive core processing of digital samples received from the RF front end, it may be seen that digital samples generated by the computing device for transmission by the RF front end are similarly processed. For example, in the case of digital samples to be transmitted, steps 954-960 are the same, with the input being a bit stream generated or received by the computing device, such as from an application, and the output being processed digital samples ready for conversion to analog and transmission by the RF front end.

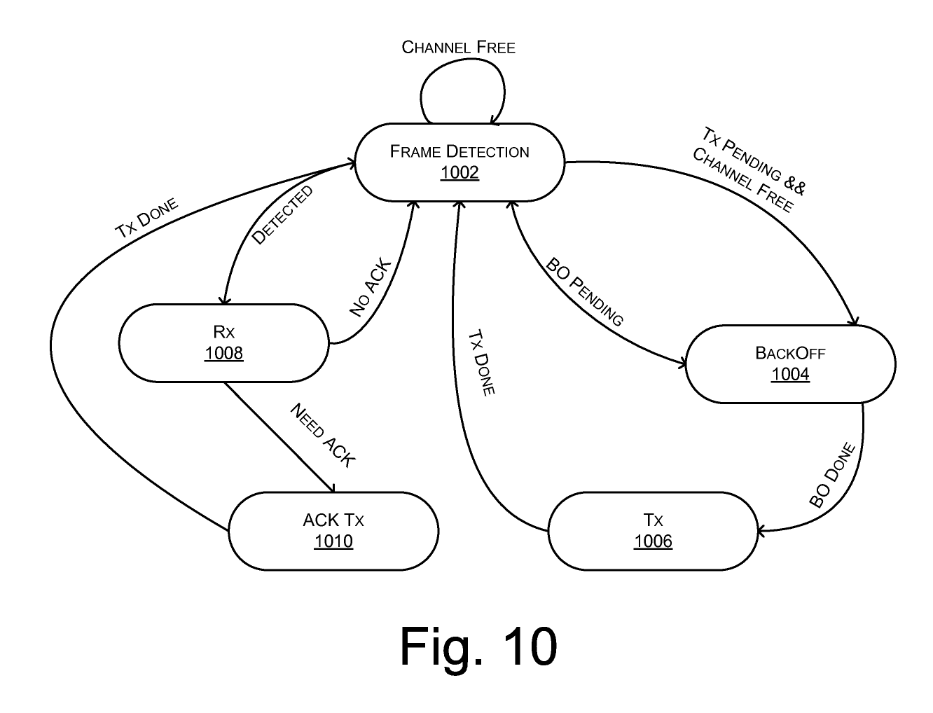

Further, the exemplary WiFi implementation 900 is able to implement the basic access mode of the 802.11 standard. Exemplary details of the MAC State Machine are illustrated in FIG. 10. Normally, the SM is in the Frame Detection (FD) state 1002. In the frame detection state 1002, the RCB 904 constantly writes samples into the Rx_buf 924. The SM (i.e. MAC_SM_Thread 906) continuously measures the average energy to determine whether the channel is clean or whether there is an incoming frame.

The transmission of a frame follows the carrier-sense multiple access (CSMA) mechanism. When there is a pending frame to be transmitted, the SM first checks whether the energy on the channel is low (i.e., no frame is currently being received). If the channel is busy, the transmission is deferred and a backoff timer 1004 is started. Each time the channel becomes free, the SM checks if any backoff time remains. If the timer goes to zero, the SM transmits the pending frame at block Tx 1006.

Further, when the exemplary WiFi implementation starts to receive a frame, it detects a high energy in the frame detection state 1002. In 802.11, SM uses three steps in the PHY layer to receive a frame at block Rx 1008. First, the PHY layer needs to synchronize to the frame, i.e., find the starting point of the frame (timing synchronization) and the frequency offset and phase of the sample stream (carrier synchronization). Synchronization is usually done by correlating the incoming samples with a pre-defined preamble. Subsequently, the PHY layer needs to demodulate the PLCP (Physical Layer Convergence Protocol) header, which is always transmitted using a fixed low-rate modulation mode. The PLCP header contains the length of the frame as well as the modulation mode, possibly a higher rate, of the frame data that follows. Thus, only after successful reception of the PLCP header will the PHY layer know how to demodulate the remainder of the frame.

After successfully receiving a frame at Rx 1008, the 802.11 MAC standard requires a receiving station to transmit an ACK frame in a timely manner as indicated at block ACK Tx 1010. For example, 802.11b requires that an ACK frame be sent with no more than a 10 μs delay to acknowledge receipt of the received frame. However, this short ACK requirement is quite difficult for an SDR implementation to achieve in software on a general-purpose computing device. Both generating and transferring the waveform across the system bus can cause a latency of several microseconds, and total time required is usually larger than the maximum amount mandated by the standard. Fortunately, an ACK frame generally has a fixed pattern. For example, in 802.11 all data in an ACK frame is fixed except for the sender address of the corresponding data frame. Thus, in the exemplary WiFi implementation 900, it is possible to pre-calculate most of an ACK frame (19 bytes), and update only the address (10 bytes). Further, this can be done early in the processing, immediately after demodulating the MAC header, and without waiting for the end of a frame. The waveform is then pre-stored into the memory of the RCB. Thus, the time for ACK generation and transferring can overlap with the demodulation of the data frame being received. After the MAC SM demodulates the entire frame and validates the CRC32 checksum, the MAC SM instructs the RCB to transmit the ACK, which has already been stored on the RCB. Thus, the latency for ACK transmission is very small because the ACK is already stored in the RCB and can be immediately transmitted without having to be generated or sent along the system bus.

In rare cases when the incoming data frame is quite small (e.g., the frame contains only a MAC header and zero payload), then the exemplary WiFi implementation cannot fully overlap ACK generation and the DMA transfer with demodulation to completely hide the latency. In this case, the exemplary WiFi implementation may fail to send the ACK in time. This problem is addressed by maintaining a cache of previous ACKs in the RCB. With 802.11, all data frames from one node will have exactly the same ACK frame. Thus, pre-allocated memory slots in the RCB can be used to store ACK waveforms for different senders (in some implementations, 64 different slots are allocated). Therefore, when demodulating a frame, if the ACK frame is already in the RCB cache, the MAC SM simply instructs the RCB to transmit the pre-cached ACK. With this scheme, the exemplary WiFi implementation may be late on the first small frame from a sender, effectively dropping the packet from the sender's perspective. But the retransmission, and all subsequent transmissions, will find the appropriate ACK waveform already stored in the RCB cache.

The exemplary WiFi implementation 900 has been implemented and tested as a full 802.11a/g/b transceiver, which support DSSS (Direct Sequence Spreading: 1 and 2Mbps in 11b), CCK (Complementary Code Keying: 5.5 and 11 Mbps in 11b), and OFDM (Orthogonal Frequency Division Multiplexing: 6, 9 and up to 54 Mbps in 802.11a/g).

Accordingly, implementations of the SDR herein have been found to interoperate seamlessly with commercial hardware-based 802.11 devices, while supporting the full suite of 802.11a/b/g modulation rates and achieving substantially equivalent performance to the hardware-based devices at each modulation. As a result, it may be seen that implementations of the SDR herein can process signals sufficiently fast to achieve full channel utilization, and that the SDR can satisfy all timing requirements of the 802.11 standards with a software implementation on a general-purpose computing device.

### Analysis Applications

Wireless testing, measurement and analysis instruments can be broadly classified as either generators or analyzers. For example, a generator is used to generate a required signal, i.e., from very basic sine waveform to complex signals that contain modulated frames. On the other hand, analyzers obtain a signal, such as from the air, and extract information contained in the signal, e.g., from a basic energy spectrum to high level semantics, such as wireless protocols Implementations herein provide analysis tools that can incorporate either or both generators and analyzers. For instance, various types of analysis tools, such as oscilloscopes, spectrum analyzers and other signal and waveform analysis tools can be implemented on the computing devices described herein and operated simultaneously with the SDR described herein for carrying out testing, measurement, analysis, and the like, during SDR processing and operation. For example, oscilloscopes and spectrum analyzers can provide an analysis of a generated radio signal amplitude against time, frequency, etc., and display the results in real time, such as on a graphical user interface. Such analysis tools can be useful for testing existing wireless standards, new radio protocols, testing experimental software-defined radio configurations, and the like.

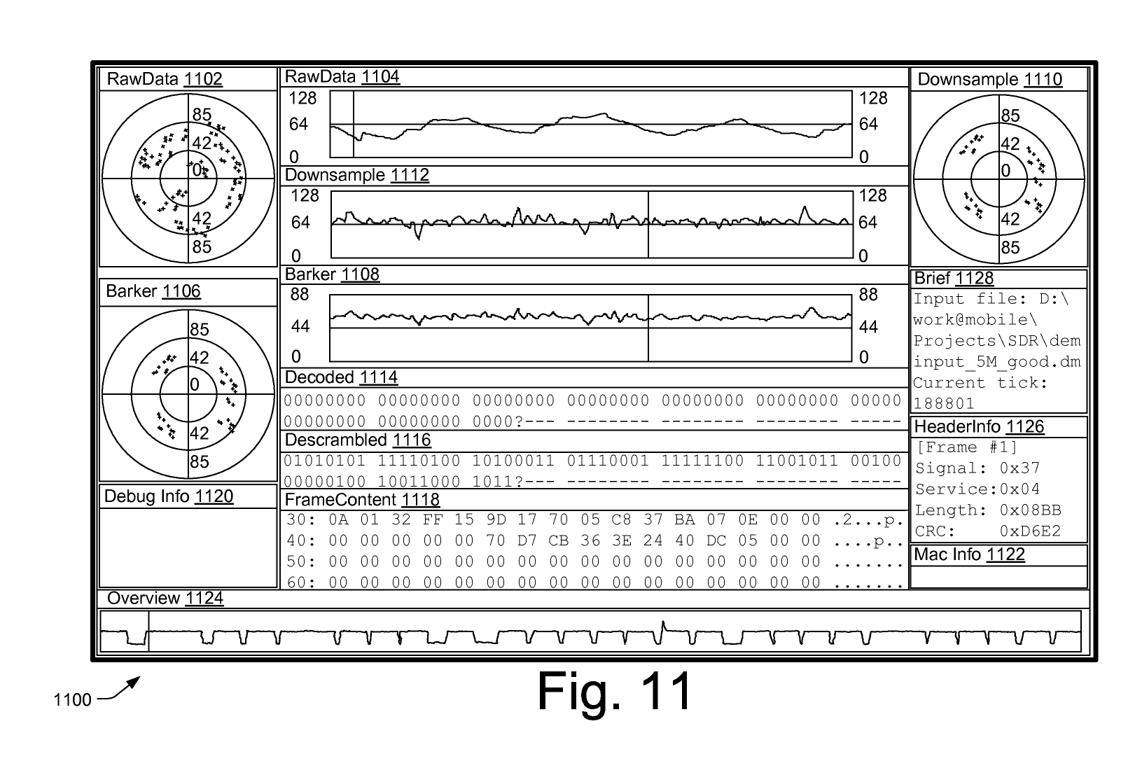

FIG. 11 illustrates a graphical user interface (GUI) 1100 of a testing and analysis tool according to some implementations herein that can be implemented as an analysis application on the general-purpose computing device disclosed herein for use in testing, measuring and analyzing the performance of the SDR herein. The example of FIG. 11 illustrates a software spectrum analyzer, which is one of the various types of testing, measurement and analysis applications that may be implemented (referred to hereinafter as “analysis applications”). For example, it is straightforward for implementations of the SDR herein to expose all PHY layer information to analysis applications running on the computing device. A software spectrum analyzer is such an application that can take advantage of this information. For example, the spectrum analyzer illustrated in FIG. 11 can run on one or more cores of the processor of the general-purpose computing device while the SDR is in operation, and can graphically display the waveform and modulation points of the radio communications in one or more constellation graphs, as well as presenting the demodulated results. In the implementation illustrated in FIG. 11, raw data, down sampled data, and data after barker correlation are displayed in both constellation graphs and waveform graphs. In particular, the GUI 1100 includes a raw data constellation graph 1102, a raw data waveform graph 1104, a barker constellation graph 1106, a barker waveform graph 1108, a downsample constellation graph 1110 and a downsample waveform graph 1112. Also displayed are decoded information 1114, descrambled information 1116, frame content 1118, debug info 1120, MAC info 1122, overview info 1124, header info 1126 and a brief description of file information 1128. Further, while commercially available specialized spectrum analyzers may provide a similar functionality and a wider sensing spectrum band, they are also more expensive and do not provide the functionality provided by running on the same computing device as the software-defined radio herein, as is discussed further below.

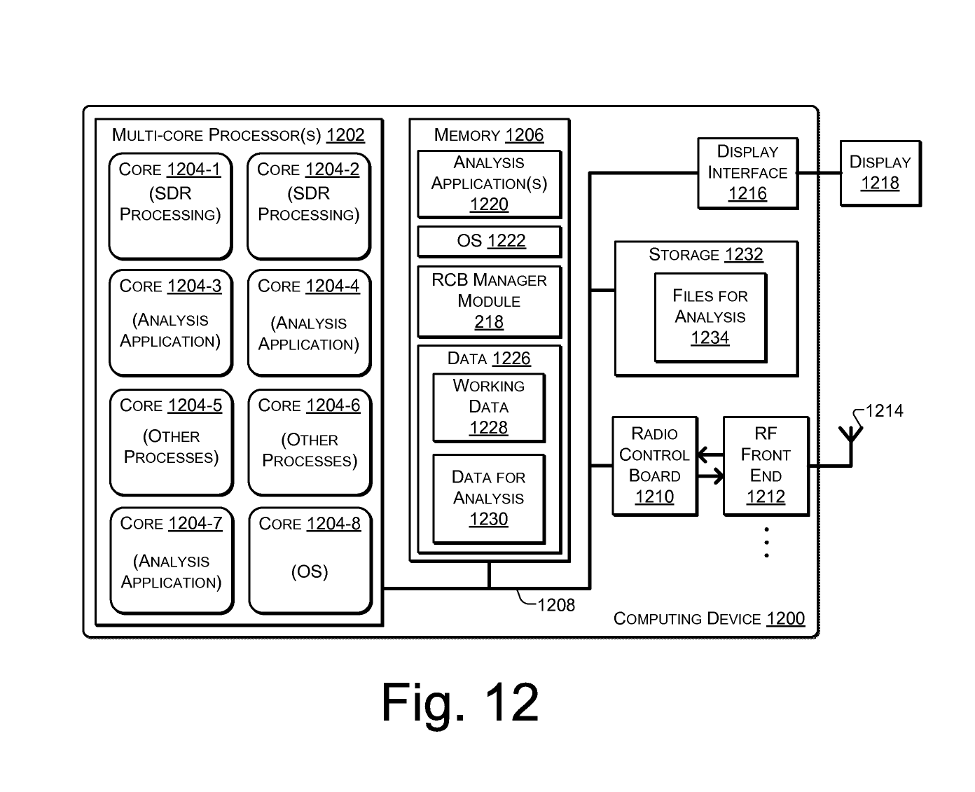

FIG. 12 illustrates a computing device 1200 which may correspond to any of the computing devices described herein, such as computing devices 200, 902. Computing device 1200 includes one or more multi-core processors 1202, which may correspond to any of multi-core processors 102, 202 described herein, having a plurality of processing cores 1204, such as eight cores 1204-1, . . . , 1204-8. A memory 1206 is in communication with multi-core processor 1202 via a system bus 1208. As described above, system bus 1208 may be a high-speed system bus such as a PCIe system bus or the like. An RCB 1210, which may correspond to RCBs 116, 214, 302, 904 described herein, is also in communication with system bus 1208. RCB 1210 has an RF front-end 1212 coupled thereto for receiving and transmitting RF signals via an antenna 1214, as discussed above. Computing device 1200 further includes a display interface 1216, which may be a video card having a graphics processing unit, coupled to a display 1218. Display 1218 can be used for displaying testing, measurement and other analysis results on a graphic user interface, such as the GUI 1100 of FIG. 11, which displays the results of a software spectrum analyzer. The graphic user interface can be a displayed as a window with multiple fixed or floating sub-windows, each presenting various types of information on the testing and analysis, such as the examples discussed above with respect to FIG. 11. It should be noted that the content of the particular windows and the GUI will vary, depending on the particular parameters being tested and analyzed.

Memory 1206 includes one or more analysis applications 1220 that are able to execute on computing device 1200 simultaneously with the functioning of the RCB 1210 and RF front end 1212 for implementing a software-defined radio on one or more dedicated cores of processor 1202, as described above. For example, an analysis application 1220 may provide the spectrum analyzer 1100 described above with reference to FIG. 11, or other testing, measurement and/or analysis functions. Memory 1206 further includes an operating system (OS) 1222, RCB manager module 218, described above with reference to FIG. 2 for managing RCB interaction with the computing device 1200, and data 1226. Data 1226 may include various types of data used by computing device 1200. In the illustrated embodiment, data 1226 includes working data 1228 and data stored for analysis 1230. Working data 1228 corresponds, for example, to digital samples that are temporarily stored in the memory 1206 during SDR processing, including digital samples stored in the memory by direct memory access as discussed above, such as with reference to FIGS. 4 and 9A. On the other hand, data for analysis 1230 includes digital samples and other data that is collected during testing and analysis of the SDR configuration by the analysis application 1220. This data for analysis 1230 is subsequently stored in storage 1232, such as a hard drive or other mass storage device, in one or more files for analysis 1234, and is then accessible at a later time for further offline processing and analysis.

In the configuration illustrated in FIG. 12, one or more analysis applications 1220 are executed on computing device 1200 during which time the computing device also carries out the SDR processing as discussed above. For example, the SDR processing may be carried out on one or more dedicated cores 1204 of multi-core processor 1202. In the illustrated example, two cores 1204-1, 1204-2 are dedicated to SDR processing using exclusive threads, as described above, such as with reference to FIGS. 9A-9B. As describe above, dedicated SDR processing on one more cores can be established by initiating a kernel thread for SDR processing, and raising a priority of the kernel thread and/or an interrupt request level of the kernel thread so that the kernel thread runs exclusively on a particular core until termination. Thus, the exclusive threads on cores 1204-1, 1204-2 can carry out PHY layer processing, MAC layer processing and other SDR processing without being susceptible to interrupts, as described above, thereby dedicating those two cores 1204-1, 1204-2 to SDR processing. The one or more analysis applications 1220 can utilize at least some of the remaining cores 1204-3 through 1204-8 of processor 1202 for testing, measurement and/or analysis functions with respect to the SDR processing being carried out on the cores 1204-1, 1204-2, and the signals being generated by the computing device 1200 or received or transmitted by the RF front end 1212. Thus, because the SDR processing is executed on different cores from the analysis application(s), the SDR is able to function normally on the computing device during testing and analysis, and the SDR processing is not significantly affected by the execution of the analysis application(s), so that the analysis application(s) are able to achieve accurate testing results, such as would be achieved if the analysis applications were executed or carried out on a separate piece of equipment.

In the illustrated example, cores 1204-3, 1204-4, 1204-7 are being utilized by the analysis application 1220, while the other available cores 1204-5, 1204-6, 1204-8 can be utilized by other processes executing on computing device 1200 or by the operating system 1222. Because the analysis application 1220, the operating system 1222, and the other processes do not operate exclusively on any particular core 1204, the particular cores utilized by each of these will change over time as the analysis application, the other processes, and/or the operating system become active or inactive, initiate or respond to interrupts, or the like. However, as discussed above, the SDR processing on cores 1204-1, 1204-2 will typically not be interrupted because of the use of the exclusive threads and other techniques described above. Additionally, in some implementations, it may be desirable for the analysis application to also operate exclusively on one or more cores without interruption. Accordingly, this may also be carried out using an ethread, as discussed above. Furthermore, in an alternative implementation, computing device 1200 may include coprocessors (not illustrated) for executing analysis on the data for analysis 1230 stored in the files for analysis 1234. Still alternatively, a graphics processing unit (GPU) in the display interface 1216 may be utilized for at least a portion of the analysis processing. Accordingly, it may be seen that this arrangement presented herein enables researchers to experiment with various different software radio configurations using the architecture disclosed herein and simultaneously perform testing, measurement, data processing and other analysis of the various configurations using the same computing device as that on which the software-defined radio is operating.

Additionally, because the analysis application 1220 is executing on the same computing device 1200 as the SDR, the analysis application 1220 can be configured to provide feedback to the SDR based upon the results of the testing, measurement and/or analysis. For example, following measurement and analysis of one or more digital samples, or the like, the results can be used as feedback for immediately and automatically adjusting parameters of the SDR processing, such as gain, frequency, sampling rate, and numerous other parameters that affect the function, efficiency, and other considerations of the SDR. For example, feedback may be delivered to the RCB and thereby affect an RF signal emitted by the RF front end for causing a variation in the RF signal based on the analysis of the data collected. Further, for example, the analysis application can even reconfigure the SDR processing. For example, the analysis application may instruct the SDR processing module to change the processing algorithm, and/or add or delete certain processing blocks. Further, for example, the data collected can be processed immediately online, and used as feedback to affect the SDR in real time, and/or the data collected can be stored in the storage 1232, analyzed offline, and the results can be stored back into storage 1232 for presentation on display 1218 for further consideration by the researchers after the SDR processing has been completed. Further, for example, the analysis application may also instruct the SDR processing module to generate a certain response for certain incoming signals. For example, a protocol testing application may instruct the SDR processing module to return a faked frame to test the correctness of protocol implementation on the sender side.

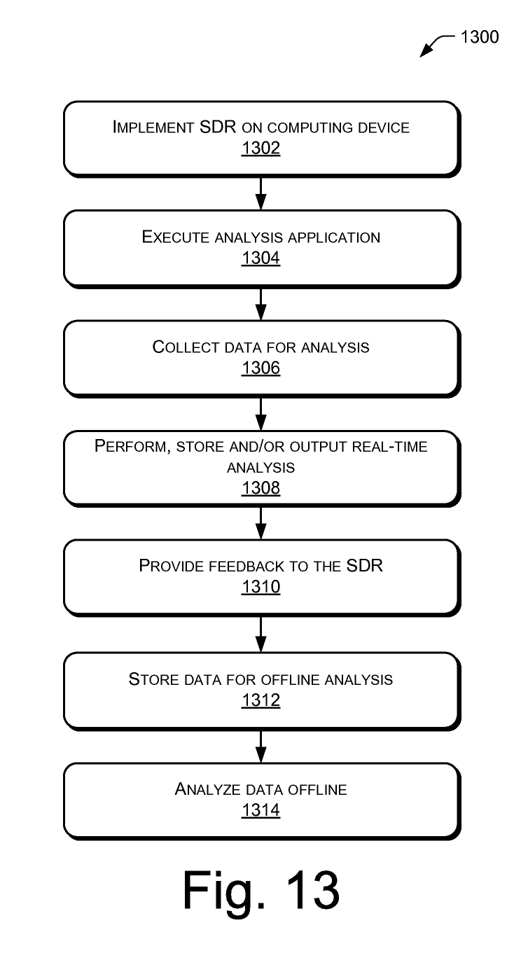

FIG. 13 illustrates a block diagram of an exemplary process 1300 for SDR testing and analysis according to implementations herein. The process 1300 may be carried out by processor 1202 executing instructions stored in memory 1206 or other computer-readable storage media.

At block 1302, SDR processing is carried out using one or more exclusive threads on one or more cores of a multi-core processor of a computing device for providing SDR functionality.

At block 1304 an analysis application is executed for carrying out testing, measurement, and/or analysis of the SDR. For example, the analysis application may include spectrum analysis, an oscilloscope, or other analysis functions for determining whether the implementation of wireless standards or other radio technologies is performing according to expected/desired parameters, or the like.

At block 1306, the analysis application collects data for analysis. For example, the application may collect one or more digital samples while the digital samples are being processed at certain stages of the SDR processing. The analysis application may also perform numerous other functions such as timing certain aspects of the SDR processing, measuring the amount of data passed through the SDR processing, testing or measuring signals generated or received by the RF front end, or the like.

At block 1308, the analysis application may optionally perform, store and/or output real-time analysis of the collected data. For example, the analysis application may display waveforms, constellation graphs, spectrum density graphs, eye-graphs or other data on a graphical user interface, such as is illustrated in FIG. 11, as the data is being collected.

At block 1310, the analysis application may optionally provide online feedback to the SDR processing, the RCB, the RF front end, control software, or the like, for effecting a change in one or more parameters or the processing flow of the SDR.

At block 1312, the data collected for analysis can be stored in storage for later analysis. For example, the data collected for analysis can be stored in one or more files in a hard drive or other mass storage device, either in the computing device, or in a location in communication with the computing device.

At block 1314, the data stored in the storage for later analysis can be processed and analyzed offline at a later time following completion of the SDR processing being tested, measured, analyzed, or the like. Further, while an exemplary block diagram has been has been set forth in FIG. 13 and described above, it will be apparent to those skilled in the art that numerous variations are possible in light of the disclosure herein.

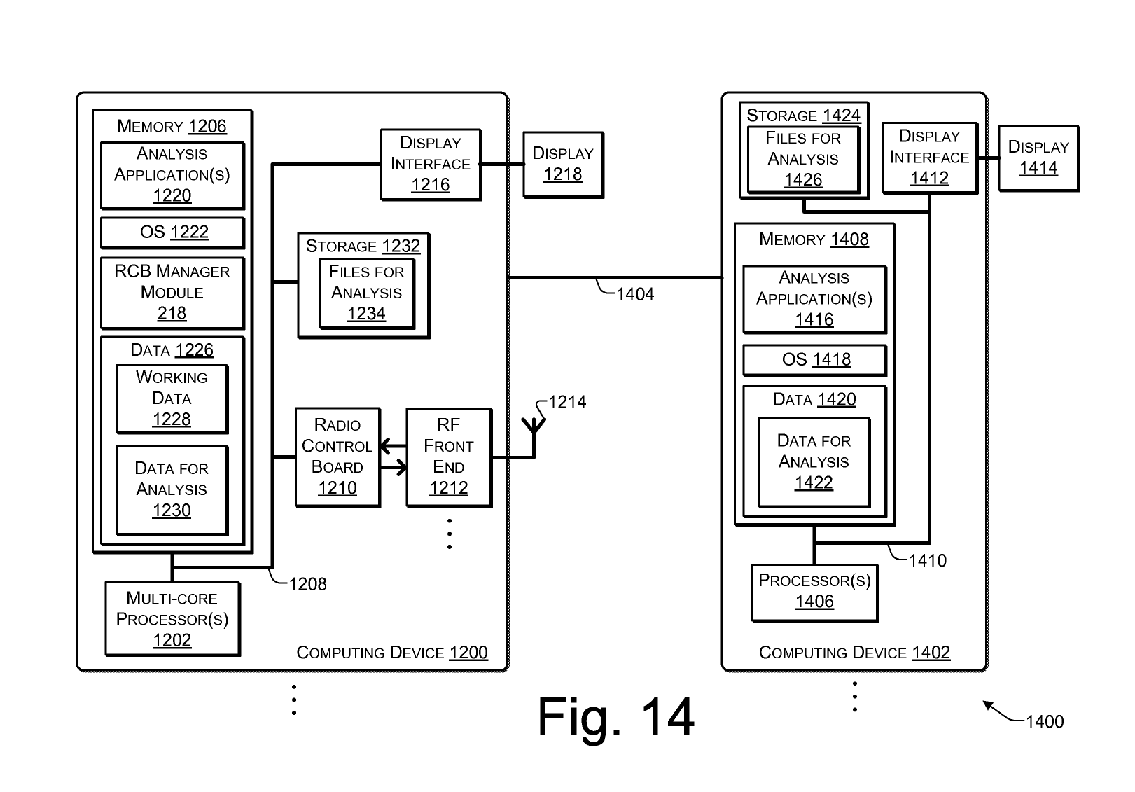

FIG. 14 illustrates a system 1400 according to an additional implementation. System 1400 includes one or more computing devices 1200 in communication with one or more additional computing devices 1402, which may form a cluster for experimental testing, measurement, analysis, reconfiguration and the like. Each computing device 1402 may be in communication with a computing device 1200 by various communication architectures 1404, such as a direct bus connection (e.g., PCIe or SATA), a wired or optic connection, a local area network (LAN) connection, a wide area network (WAN) connection, including the Internet, or other suitable connections enabling communication of data. Computing device 1402 includes one or more processors 1406, which may be a single or multi-core processor. A memory 1408 is in communication with the processor 1406 via a system bus 1410. Computing device 1402 further includes a display interface 1412, which may be a video card having a GPU, coupled to a display 1414. Display 1414 can be used for displaying testing, measurement and other analysis results on a graphic user interface, such as the GUI 1100 of FIG. 11.

Memory 1408 includes one or more analysis applications 1416 that are able to execute on computing device 1402 for performing measurement, testing and analysis of wireless standards, radio technology, or other radio activity taking place on computing device 1200. For example, an analysis application 1416 may provide the spectrum analyzer 1100 described above with reference to FIG. 11, or other testing, measurement and/or analysis functions. Further, the analysis application 1416 may coexist and interact with one or more analysis applications 1220 on computing device 1220, or the analysis application on 1416 may take the place of the analysis application(s) 1220 on computing device 1200. Memory 1206 further includes an operating system (OS) 1418 and data 1420. Data 1420 may include various types of data used by computing device 1402. In the illustrated embodiment, data 1402 includes data for analysis 1422. Data for analysis 1422 includes digital samples and other data that is collected during testing and analysis of the SDR configuration by the analysis application 1408, and may be the same or different from data for analysis 1230 on computing device 1200. The data for analysis 1422 is subsequently stored in storage 1424, such as a hard drive or other mass storage device, in one or more files for analysis 1426, and is accessible at a later time for further offline processing and analysis. In some implementations, there will be no data for analysis 1230 or files for analysis 1234 stored on the computing device 1200 having the SDR implemented. In other implementations, for example, when one or more analysis applications are running on both computing device 1200 and computing device 1402, data for analysis 1230, 1422 may be stored on each computing device 1200, 1402.

In the configuration illustrated in FIG. 14, one or more analysis applications 1416 are executed on computing device 1402, during which time the computing device 1200 carries out SDR processing as discussed above. Additionally, the analysis application 1416 can be configured to provide feedback to the SDR based upon the results of the testing, measurement and/or analysis, as discussed above, by passing the feedback through the communication architecture 1404. As another example, one or more computing devices 1402 may be in communication with two or more computing devices 1200 via the communication architecture 1404, while the two or more computing devices 1200 are configured to communicate with each other via RF front ends 1212. In this configuration, an analysis application 1416 on computing device 1402 may receive data for analysis 1422 from the two or more computing devices 1200 for carrying out desired testing, measurement and analysis functions. Alternatively, as yet another example, multiple computing devices 1402 may be in communication with a single computing device 1200 via communication architecture 1404, with each of the multiple computing devices 1402 running a different analysis application 1416 for providing different analysis aspects. Other variations will also be apparent to those of skill in the art in light of the disclosure herein.

Accordingly, it may be seen that implementations herein enable efficient and convenient testing, measuring and/or analyzing of various wireless technologies that can be implemented using the SDR platform described herein Implementations allow the analysis application to execute on the same general-purpose computing device as the software-defined radio. This further enables real-time feedback to be carried out for adjusting parameters or processing flow of the software-defined radio, while also providing for greater ease of use for researchers for experimenting with various new or modified protocols, software radio configurations, or the like, on the SDR platform provided herein. Further, other implementations provide for analysis applications on one or more connected computing devices to perform analysis functions and also interact and provide feedback to one or more computing devices having the SDR platform implemented.

### Extensions to Radio Protocols

The flexibility of implementations of the SDR herein allows the development and testing of extensions to current radio protocols, such as 802.11.

### Jumbo Frames

When channel conditions are good, transmitting data using larger frames can reduce the overhead of MAC/PHY headers, preambles and the per frame ACK. However, the maximal frame size of 802.11 is fixed at 2304 bytes. With simple modifications (changes in a few lines to the PHY algorithms), the exemplary WiFi implementation can transmit and receive jumbo frames of up to 32 KB. For example, when two implementations of the SDR herein using the exemplary WiFi implementation described above and with jumbo frame optimization, the throughput of data can be increased. For instance, when the frame size is increased from 1 KB to 6 KB, the end-to-end throughput increases 39% from 5.9 Mbps to 8.2 Mbps. When the frame size is further increased to 7 KB, however, the throughput drops because the frame error rate also increases with the size. Thus, at some point, the increasing error will offset the gain of reducing the overhead. However, it is noted that default commercial hardware-based NICs reject frames larger than 2304 bytes, even if those frames can be successfully demodulated. Additionally, it is further noted that although the ability to transmit jumbo frames is only one possible optimization, the ability demonstrates that the full programmability offered by implementations of the SDR herein enables researchers to explore such “what if” questions using an inexpensive general purpose computing device SDR platform.

### TDMA MAC

To evaluate the ability of implementations of the SDR herein to precisely control the transmission time of a frame, a simple time division multiple access (TDMA) MAC algorithm was implemented that schedules a frame transmission at a predefined time interval. The MAC state machine (SM) runs in an ethread as discussed above with respect to FIG. 9, and the MAC SM continuously queries a timer to check whether the predefined amount of time has elapsed. If so, the MAC SM instructs the RCB to send out a frame. The modification is simple and straightforward with about 20 lines of additional code added to the MAC algorithm.

Since the RCB can indicate to the exemplary WiFi implementation when the transmission completes, and the exact size of the frame is known, it is possible to calculate the exact time when the frame transmits. Tests were conducted with various scheduling intervals under a heavy load, during which files on the local disk are copied, files from a nearby server are download, and a HD video is played back simultaneously, for determining an average error and standard deviation of the error. The average error was found to be less than 1 μs, which is sufficient for most wireless protocols. Also, outliers, which are define as packet transmissions that occur later than 2 μs from the pre-defined schedule, occurred less than 0.5% of the time.

### Additional Implementations

Implementations of the SDR herein provide a fully programmable software-defined radio platform on a general-purpose computing device architecture Implementations of the SDR herein combine the performance and fidelity of hardware-based SDR platforms with the programming flexibility of GPP-based SDR platforms Implementations of the SDR platform herein have been described in some examples in the context of realizing a software radio that operates using the 802.11a/b/g protocols. However, implementing additional types of software radios, such as 3GPP LTE (Long Term Evolution), W-CDMA, GSM 802.11n, WiMax and various other radio protocols and standards can also be achieved using the SDR platform herein. The flexibility provided by implementations of the SDR herein makes it a convenient platform for experimenting with novel wireless protocols, such as ANC (Analog Network Coding) or PPR (Partial Packet Recovery). Further, by being able to utilize multiple cores, implementations of the SDR herein can scale to support even more complex PHY algorithms, such as MIMO (Multiple-Input Multiple-Output) or SIC (Successive Interference Cancellation).

In addition, implementations herein are not necessarily limited to any particular programming language. It will be appreciated that a variety of programming languages may be used to implement the teachings described herein. Further, it should be noted that the system configurations illustrated in FIGS. 1, 2, 3, 4, 5, 8 and 9 are purely exemplary of systems in which the implementations may be provided, and the implementations are not limited to the particular hardware configurations illustrated.

It may be seen that this detailed description provides various exemplary implementations, as described and as illustrated in the drawings. This disclosure is not limited to the implementations described and illustrated herein, but can extend to other implementations, as would be known or as would become known to those skilled in the art. Reference in the specification to “one implementation”, “this implementation”, “these implementations” or “some implementations” means that a particular feature, structure, or characteristic described in connection with the implementations is included in at least one implementation, and the appearances of these phrases in various places in the specification are not necessarily all referring to the same implementation. Additionally, in the description, numerous specific details are set forth in order to provide a thorough disclosure. However, it will be apparent to one of ordinary skill in the art that these specific details may not all be needed in all implementations. In other circumstances, well-known structures, materials, circuits, processes and interfaces have not been described in detail, and/or illustrated in block diagram form, so as to not unnecessarily obscure the disclosure.

### CONCLUSION

Implementations described herein provide for testing, measurement and/or analysis of various wireless standards, radio configurations, communication protocols and other radio technologies based on an SDR or SDR platform implemented on one or more computing devices, and provide for real-time results and/or feedback based upon the testing, measurement and/or analysis. Additionally, implementations herein provide for an SDR platform and a high-performance PHY processing library. Implementations of the SDR herein use both hardware and software techniques to achieve high throughput and low latency on a general-purpose computing device architecture for achieving a high-speed SDR Implementations include an SDR platform that enables users to develop high-speed radio implementations, such as IEEE 802.11a/b/g PHY and MAC, entirely in software on general-purpose computing device architecture. For example, time critical tasks, MAC and PHY processing can be changed and reprogrammed as desired for achieving various purposes. Further, a particular example of the SDR has been described that includes an exemplary WiFi radio system that can interoperate with commercial wireless NICs using 802.11a/b/g standards.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims Additionally, those of ordinary skill in the art appreciate that any arrangement that is calculated to achieve the same purpose may be substituted for the specific implementations disclosed. This disclosure is intended to cover any and all adaptations or variations of the disclosed implementations, and it is to be understood that the terms used in the following claims should not be construed to limit this patent to the specific implementations disclosed in the specification. Instead, the scope of this patent is to be determined entirely by the following claims, along with the full range of equivalents to which such claims are entitled.

1. A computing device comprising:
a multi-core processor coupled to a memory by a system bus;
a radio frequency (RF) front end coupled to a radio control board, wherein the radio control board is coupled to the system bus for passing information between the RF front end and the memory for implementing a software-defined radio on the computing device;
an analysis application stored in the memory and adapted to be executed by the multi-core processor for collecting data for analysis of the software-defined radio implemented on the computing device,
wherein processing for the software-defined radio is carried out by one or more first cores of the multi-core processor, and processing for the analysis application is carried out by one or more second cores of the multi-core processor, so that the analysis application collects the data for analysis while the processing for the software-defined radio is taking place, without significantly affecting the processing for the software-defined radio.

2. The computing device according to claim 1, wherein the analysis application is configure to provide feedback to the software-defined radio for adjusting one or more parameters, a processing flow, or a generated response of the software-defined radio in response to the data for analysis collected by the analysis application.

3. The computing device according to claim 1, wherein the analysis application is configured to store the data for analysis in a storage on the computing device and perform analysis of the data for analysis in an offline mode at point in time following completion of the processing for the software-defined radio.

4. The computing device according to claim 1,
wherein the analysis application is configured to provide a graphical user interface (GUI) on a display in communication with the computing device,
wherein the GUI displays the data for analysis collected by the analysis application while the processing for the software-defined radio is ongoing on the computing device.

5. The computing device according to claim 1, wherein the one or more first cores are dedicated to processing for the software-defined radio by initiating a kernel thread for the processing for the software-defined radio, raising a priority of the kernel thread and/or an interrupt request level of the kernel thread so that the kernel thread runs exclusively on a particular first core until termination.

6. The computing device according to claim 1, wherein the bus is a Peripheral Component Interconnect Express (PCIe) bus.

7. A method implemented on a computing device, the method comprising:
coupling a radio frequency (RF) transceiver to a system bus of a computing device having a multi-core processor and a memory;
performing processing on the computing device for implementing a software-defined radio;
performing analysis of the software-defined radio by collecting and analyzing data related to the software-defined radio while the processing for the software-defined radio is taking place.

8. The method according to claim 7, further comprising providing feedback based on the data collected and analyzed to change at least one aspect of the software-defined radio while the processing for the software-defined radio is taking place.

9. The method according to claim 7, wherein the RF transceiver is coupled to the system bus using a radio control board that controls exchange of digital samples between the RF transceiver and the memory of the computing device.

10. The method according to claim 7, further comprising outputting a graphical user interface (GUI) to a display in communication with the computing device, wherein the GUI displays results of the analyzing while the processing for the software-defined radio is ongoing on the computing device.

11. The method according to claim 7, wherein one or more first cores of the multi-core processor are dedicated to the processing for the software-defined radio, while one or more second cores of the multi-core processor execute one or more applications for performing the analysis.

12. The method according to claim 11, wherein the one or more first cores are dedicated to processing of the digital samples by initiating a kernel thread for processing the digital samples, and raising the priority of the thread and/or an interrupt request level of the kernel thread so that the kernel thread runs exclusively on a particular first core until termination.

13. The method according to claim 7, wherein the digital samples are passed between the RF transceiver and the memory of the computing device on a Peripheral Component Interconnect Express (PCIe) bus.

14. The method according to claim 7,
wherein the computing device is a first computing device, and
wherein the performing analysis of the software-defined radio by collecting and analyzing data related to the software-defined radio takes place on a second computing device in communication with the first computing device.

15. A computing device comprising:
a processor coupled to a memory via a bus;
a radio frequency (RF) front end coupled to the bus for implementing a software-defined radio on the computing device;
an analysis application stored in the memory and adapted to be executed by the processor for collecting data for analysis from the software-defined radio implemented on the computing device.

16. The computing device according to claim 15, further comprising a radio control board for coupling the RF front end to the bus, wherein the radio control board is configured to interface with the bus for passing digital samples between the RF front end and the memory of the computing device for implementing the software-defined radio.

17. The computing device according to claim 15, wherein the analysis application performs analysis of the data for analysis collected in real time for providing results of the analysis as processing for the software-defined radio is taking place on the computing device.

18. The computing device according to claim 15, wherein the analysis application is configure to provide feedback to the software-defined radio for adjusting one or more parameters or changing a processing flow or a generated response of the software-defined radio in response to the data for analysis collected by the analysis application.

19. The computing device according to claim 15,
wherein the analysis application is configured to provide a graphical user interface (GUI) on a display coupled to the computing device,
wherein the GUI displays the data for analysis collected by the analysis application while processing for the software-defined radio is taking place on the computing device.

20. The computing device according to claim 15,
wherein the processor is a multi-core processor having one or more first cores and one or more second cores,
wherein processing for the software-defined radio is carried out by the one or more first cores of the multi-core processor, and processing for the analysis application is carried out by one or more second cores of the multi-core processor.
